(19) United States
(12) Patent Application Publication
(10) Pub. No.: US 2006/0112061 A1
(43) Pub. Date: May 25, 2006

(54) Rule based engines for diagnosing grid-based computing systems

(76) Inventor: Vijay B. Masurkar, Chelmsford, MA (US)

Correspondence Address: HOGAN & HARTSON LLP, ONE TABOR CENTER, SUITE 1500, 1200 SEVENTEEN ST., DENVER, CO, 80202, US

(21) Appl. No.: 11/284,672

(22) Filed: Nov. 22, 2005

Related U.S. Application Data
(63) Continuation-in-part of application No. 11/168,710, filed on Jun. 28, 2005.
Application No. 11/168,710 is a continuation-in-part of application No. 10/875,329, filed on Jun. 24, 2004.

(51) Int. Cl. G06N 5/02

(52) U.S. Cl. 706/47

(57) ABSTRACT

Disclosed herein is the creation and utilization of autonomic agents that may be utilized on demand by service engineers to remotely diagnose and address faults, errors and other conditions within a grid-based computing system, and related computerized processes and network architectures and systems supporting such agents. The autonomic diagnostic agents can comprise software driven rules engines that operate on facts or data, such as telemetry and event information and data in particular, according to a set of rules. The autonomic diagnostic agents execute in accordance with the rules based on the facts and data found in the grid-based system, and then make a determination about the grid. The operations of a particular agent varies depending upon the status and configuration of the particular grid-based system being diagnosed as dictated by the database of rules. Particular memory allocations, diagnostic process and subprocess interactions, and rule constructs are disclosed.

### CROSS-REFERENCE TO RELATED APPLICATIONS

The present application is a continuation-in-part of co-pending U.S. patent application Ser. No. 11/168,710, filed Jun. 28, 2005, which in turn is a continuation-in-part of co-pending U.S. patent application Ser. No. 10/875,329, filed Jun. 24, 2004.

### BACKGROUND OF THE INVENTION

1. Field of the Invention

The present invention relates, in general, to computing methods for remotely diagnosing faults, errors, and conditions within a grid-based computing system. More particularly, the present invention relates to automated rule based processes and computing environments for remotely diagnosing and addressing faults, errors and other conditions within a grid-based computing system.

2. Relevant Background

Grid-based computing utilizes system software, middleware, and networking technologies to combine independent computers and subsystems into a logically unified system. Grid-based computing systems are composed of computer systems and subsystems that are interconnected by standard technology such as networking, I/O, or web interfaces. While comprised of many individual computing resources, a grid-based computing system is managed as a single computing system. Computing resources within a grid-based system each can be configured, managed and used as part of the grid network, as independent systems, or as a sub-network within the grid. The individual subsystems and resources of the grid-based system are not fixed in the grid, and the overall configuration of the grid-based system may change over time. Grid-based computing system resources can be added or removed from the grid-based computing system, moved to different physical locations within the system, or assigned to different groupings or farms at any time. Such changes can be regularly scheduled events, the results of long-term planning, or virtually random occurrences. Examples of devices in a grid system include, but are not limited to, load balancers, firewalls, servers, network attached storage (NAS), and Ethernet ports, and other resources of such a system include, but are not limited to, disks, VLANs, subnets, and IP Addresses.

Grid-based computing systems and networking have enabled and popularized utility computing practices, otherwise known as on-demand computing. If one group of computer users is working with bandwidth-heavy applications, bandwidth can be allocated specifically to them using a grid system and diverted away from users who do not need the bandwidth at that moment. Typically, however, a user will need only a fraction of their peak resources or bandwidth requirements most of the time. Third party utility computing providers outsource computer resources, such as server farms, that are able to provide the extra boost of resources on-demand of clients for a pre-set fee amount. Generally, the operator of such a utility computing facility must track “chargeable” events. These chargeable events are primarily intended for use by the grid-based computing system for billing their end users at a usage-based rate. In particular, this is how the provider of a utility computing server farm obtains income for the use of its hardware.

Additionally, in grid-based systems must monitor events that represent failures in the grid-based computing system for users. For example, most grid-based systems are redundant or “self-healing” such that when a device fails it is replaced automatically by another device to meet the requirements for the end user. While the end user may not experience any negative impact upon computing effectiveness, it is nevertheless necessary for remote service engineers (“RSE”) of the grid system to examine a device that has exhibited failure symptoms. In particular, a RSE may need to diagnose and identify the root cause of the failure in the device (so as to prevent future problems), to fix the device remotely and to return the device back to the grid-based computing system's resource pool.

In conventional operation of a grid-based computing system, upon an indication of failure, a failed device in the resource pool is replaced with another available device. Therefore, computing bandwidth is almost always available. Advantages associated with grid-based computing systems include increased utilization of computing resources, cost-sharing (splitting resources in an on-demand manner across multiple users), and improved management of system subsystems and resources.

Management of grid-based systems, due to their complexity, however can be complicated. The devices and resources of a grid-based system can be geographically distributed within a single large building, or alternatively distributed among several facilities spread nationwide or globally. Thus, the act of accumulating failure data with which to diagnose and address fault problems in and of itself is not a simple task.

Failure management is further complicated by the fact that not all of the information and data concerning a failure is typically saved. Computing devices that have agents running on them, such as servers, can readily generate and export failure report data for review by a RSE. Many network devices, such as firewalls and load balancers, for example, may not have agents and thus other mechanisms are necessary for obtaining failure information.

Further, the layout and configuration of the various network resources, elements and subsystems forming a grid-based system typically are constantly evolving and changing, and network services engineers can be in charge of monitoring and repairing multiple grid-based systems. Thus, it is difficult for a network services engineer to obtain an accurate grasp of the physical and logical configuration, layout, and dependencies of a grid-based-system and its devices when a problem arises. In addition, different RSEs, due to their different experience and training levels, may utilize different diagnostic approaches and techniques to isolate the cause of the same fault, thereby introducing variability into the diagnostic process.

In this regard, conventional mechanisms for identifying, diagnosing and remedying faults in a grid-based system suffer from a variety of problems or deficiencies that make it difficult to diagnose problems when they occur within the grid-based computing system. Many hours can be consumed just by an RSE trying to understanding the configuration of the grid-based system alone. Oftentimes one or more service persons are needed to go “on-site” to the location of the malfunctioning computing subsystem or resource in order to diagnose the problem. Diagnosing problems therefore is often time consuming and expensive, and can result in extended system downtime.

When a service engineer of a computing system needs to discover and control diagnostic events and catastrophic situations for a data center, a control loop is followed to constantly monitor the system and look for events to handle. The control loop is a logical system by which events can be detected and dealt with, and can be conceptualized as involving four general steps: monitoring, analyzing, deducing and executing. In particular, the system or engineer first looks for the events that are detected by the sensors possibly from different sources (e.g., a log file, remote telemetry data or an in-memory process). The system and engineer uses the previously established knowledge base to understand a specific event it is investigating. Next, when an event occurs, it is analyzed in light of a knowledge base of information based on historically gathered facts in order to determine what to do about it. After the event is detected and analyzed, one must deduce a cause and determine an appropriate course of action using the knowledge base. For example, there could be an established policy that determines the action to take. Finally, when an action plan has been formulated, it's the executor (human or computer) that actually executes the action.

This control loop process, while intuitive, is nonetheless difficult as it is greatly complicated by the sheer size and complicated natures of grid based computing systems. Thus, there remains a need for improved computing methods for remotely diagnosing faults, errors, and conditions within a grid-based computing that takes advantage of autonomic computing capabilities; for example, self-diagnosing or self-healing.

### SUMMARY OF THE INVENTION

The present invention provides a method and system that utilizes autonomic diagnostic agents to remotely diagnose the cause of faults and other like events in a grid-based computing system. A fault is an imperfect condition that may or may not cause a visible error condition, or unexpected behavior (i.e., not all faults cause error conditions). The system and method can utilize a service interface, such as may be used by a service engineer, to the grid-based computing system environment. The service interface provides a service engine with the ability to communicate with and examine entities within those computing systems, and the ability to initiate autonomic diagnostic agents that proceed according to preset diagnostic rules and metadata to collect diagnostic related data for analysis of the fault event.

In embodiments of the invention, the service interface provided enables a user, such as an administrator and/or service engineer, to configure telemetry parameters based on the diagnostic metadata, such as thresholds which in turn enable faults messages or alarms when those thresholds are crossed, to define diagnostic rules, and to remotely receive and make decisions based upon the telemetry data. Additionally, the service interface allows a user to monitor the diagnostic telemetry information received and initiate automated or semi-automated diagnostic agent instances (“autonomic diagnostic agents”) in light of certain events.

An autonomic diagnostic agent according to embodiments of the present invention comprises a process initialized by a software script or series of scripts that operates within the grid-based system environment and, utilizing the operating system's capabilities, addresses the fault or other event by identifying possible causes of the event and, optionally, initiating one or more diagnostic agent instances to remediate or point out the faulted condition. Such autonomic diagnostic agents may additionally accumulate and send diagnostic telemetry information via the diagnostic telemetry interface to be reviewed by the user during operation and accept input from the user during execution, such as manual decisions or commands in response to the sent telemetry information.

Autonomic diagnostic agents comprise software driven rules engines that operate on facts or data (metadata), such as telemetry and event information and data in particular, according to a set of rules. The autonomic diagnostic agents therefore execute in accordance with the rules based on the facts and data found in the grid-based system, and then make a determination about the grid. Rules according to the invention are defined as software objects. The autonomic diagnostic agents are intended to perform a series of steps or operations that are defined by a particular diagnosis script, or “dscript.” As the operations of a particular dscript must vary depending upon the status and configuration of the particular grid-based system being diagnosed, each autonomic diagnostic agent bases its operations and decisions upon a database of rules for each grid-based system that defines the configuration of the system and its various constituent devices and computing resources. In this regard, a first autonomic diagnostic agent defined by a particular dscript that is initialized within a first grid-based system will differ in operation from a second diagnostic agent defined by the same identical dscript that is initialized in a second grid-based system that has a different configuration from the first.

In various embodiments of the present invention, the dscripts can include various diagnostic steps, or dsteps, and call and initiate a variety of event processor subroutines. The dsteps dictate rule-based checks, comparisons, and diagnostic actions that consult appropriate rules and then indicate the appropriate diagnostic actions to be taken subsequently based upon the results of those checks, comparisons and actions. Autonomic diagnostic agents can comprise a list of functions, such as a script of commands or function calls in an operating system language or object code language, invoked automatically via other scripts or initiated by a RSE for deciding on diagnosis for a section of a data center under question when a particular event is encountered.

In embodiments of the invention, diagnostic tasks that correspond to more complex function calls, as opposed to relatively more simple commands or command line operations, may be invoked by an autonomic diagnostic agent as semi-independent event processor subroutines. Such event processors manage units of execution work within a dscript as a result of event occurrences, which events are classified within an established event framework in the context of the data center virtualization. They can be invoked as a result of exceptional event occurrences, e.g., a fault that results in an error condition. The event processors can manage units of work represented by a collated sequence of one or more steps, and are managed consistently and independently from the other dsteps.

The operation of any given autonomic diagnostic agent is predicated by a data store of rules, which define the logical relationships of all the resources, subsystems and other elements within the grid-based system and define what kind of metadata and telemetry data is created, monitored, and/or utilized in management of the grid-based system.

In preferred embodiments of the invention, the dsteps and event processors are monitored by a web of states. In such web of states, each dstep corresponds to a unique table maintained in the database of rules. This web of states is created by a subprocess of a particular autonomic diagnostic agent instance and maintained in local memory within a diagnostic execution workspace. The autonomic diagnostic agent instance consults the web of states in the transition between various dteps and event processors invoked by the instance in order to determine the appropriate diagnostic action(s) to take in light of the set of rules.

In certain embodiments of the invention, the rules in the database can include at least four different primary types of rules that will interact in the context of an autonomic diagnostic agent and within the framework and architecture. These primary types of rules include diagnostic process rules, agent action rules, granular diagnostic rules, and foundation rules. In such embodiments of the invention, the database can also include combinatorial rules that are defined based upon two or more rules of the four primary types. Further, the database can include derived rules for the primary rule types, which can comprise an explicit conjugation of rules representing advanced knowledge of one or more of the computing resources or grid elements.

In this regard, one such embodiment of the invention includes a method for remotely diagnosing fault events in a grid-based computing system. That method includes establishing a diagnostic metadata and rules database containing rules describing elements of and configuration aspects of the grid-based computing system where the rules are software objects. The method also includes establishing one or more diagnostic scripts, with each script adapted to identify potential causes for particular fault events that may occur in the computing system. Each diagnostic script references rules in the database to analyze metadata produced by the computing system. The method further includes receiving an indication of a fault event after it occurs in the computing system, and then initiating an autonomic diagnostic agent process in the computing system according to a diagnostic script associated with the occurred event. The autonomic diagnostic agent process comprises a rules-based engine that includes a diagnostic rules state machine subprocess and a diagnostic rules process controller subprocess. The diagnostic rules state machine subprocess is adapted to load from the database into a diagnostic execution workspace the state-transition rules that establish how the engine moves between various diagnostic steps of the diagnostic script. The diagnostic rules state machine subprocess is adapted to consider the loaded rules to perform appropriate diagnostic tasks as defined by the diagnostic steps of the associated diagnostic script. The autonomic diagnostic agent process is thereby adapted to provide an indication of a possible root cause for the occurred event in light of metadata obtained from the computing system.

Additionally, another embodiment of the invention includes a computer readable medium having computer readable code thereon for remotely diagnosing grid-based computing systems. The code includes instructions for establishing an electronically accessible diagnostic metadata and rules database containing rules describing elements of and configuration aspects of the grid-based computing system, where the rules comprising software objects. The code also includes instructions for establishing one or more diagnostic scripts each adapted to identify potential causes for particular fault events that may occur in the computing system. Each diagnostic script references the rules in the database to analyze metadata produced by the computing system. The further includes instructions for receiving an indication of a fault event after it occurs in the computing system and displaying the fault to a user, and then enabling the user to initiate an autonomic diagnostic agent process in the computing system according to a diagnostic script associated with the occurred event. The autonomic diagnostic agent process comprises a rules-based engine that includes a diagnostic rules state machine subprocess and a diagnostic rules process controller subprocess. The diagnostic rules state machine subprocess is adapted to load from the database into a diagnostic execution workspace the state-transition rules that establish how the engine moves between various diagnostic steps of the associated diagnostic script. The diagnostic rules state machine subprocess is adapted to consider the loaded rules to perform appropriate diagnostic tasks as defined by the diagnostic steps of the associated diagnostic script. The autonomic diagnostic agent process thereby provides an indication of a possible root cause for the occurred event in light of metadata obtained from the computing system.

Further, another embodiment of the invention includes a grid-based computing system adapted to provide at least partially automated diagnosis of fault events, the computing system comprising a memory, a processor, a persistent data store, a communications interface, and an electronic interconnection mechanism coupling the memory, the processor, the persistent data store, and the communications interface. The persistent data store contains a diagnostic metadata and rules database storing rules describing elements of and configuration aspects of the grid-based computing system, the rules comprising software objects, and the persistent data store further contains one or more diagnostic scripts each adapted to identify potential causes for particular fault events that may occur in the computing system, each the diagnostic script referencing the rules in the database to analyze metadata from the computing system. The memory of the grid-based computing system is encoded with an application that, when performed on the processor, provides a process for processing information. The process causing the computer system to perform operations of receiving an indication of a fault event after it occurs in the computing system, and initiating an autonomic diagnostic agent process in the computing system according to a diagnostic script associated with the occurred event. The autonomic diagnostic agent process comprising a rules-based engine that includes a diagnostic rules state machine subprocess and a diagnostic rules process controller subprocess. The diagnostic rules state machine subprocess is adapted to load from the database into a diagnostic execution workspace the state-transition rules that establish how the engine moves between various diagnostic steps of the associated diagnostic script. The diagnostic rules state machine subprocess is adapted to consider the loaded rules to perform appropriate diagnostic tasks as defined by the diagnostic steps of the associated diagnostic script. The autonomic diagnostic agent process thereby provides an indication of a possible root cause for the occurred event in light of metadata obtained from the computing system.

Other arrangements of embodiments of the invention that are disclosed herein include software programs to perform the method embodiment steps and operations summarized above and disclosed in detail below. More particularly, a computer program product is one embodiment that has a computer-readable medium including computer program logic encoded thereon that when performed in a computerized device provides associated operations providing remote diagnosis of grid-based computing systems as explained herein. The computer program logic, when executed on at least one processor with a computing system, causes the processor to perform the operations (e.g., the methods) indicated herein as embodiments of the invention. Such arrangements of the invention are typically provided as software, code and/or other data structures arranged or encoded on a computer readable medium such as an optical medium (e.g., CD-ROM), floppy or hard disk or other medium such as firmware or microcode in one or more ROM or RAM or PROM chips or as an Application Specific Integrated Circuit (ASIC) or as downloadable software images in one or more modules, shared libraries, etc. The software or firmware or other such configurations can be installed onto a computerized device to cause one or more processors in the computerized device to perform the techniques explained herein as embodiments of the invention. Software processes that operate in a collection of computerized devices, such as in a group of data communications devices or other entities can also provide the system of the invention.

The system of the invention can be distributed between many software processes on several data communications devices, or all processes could run on a small set of dedicated computers, or on one computer alone.

It is to be understood that the embodiments of the invention can be embodied strictly as a software program, as software and hardware, or as hardware and/or circuitry alone, such as within a data communications device. The features of the invention, as explained herein, may be employed in data communications devices and/or software systems for such devices such as those manufactured by Sun Microsystems, Inc. of Santa Clara, Calif.

The various embodiments of the invention having thus been generally described, several illustrative embodiments will hereafter be discussed with particular reference to several attached drawings.

### BRIEF DESCRIPTION OF THE DRAWINGS

FIG. 1 is a schematic diagram depicting a conventional grid-based computing system.

FIG. 2 is a schematic diagram depicting a logical framework suitable for analyzing grid-based events in certain embodiments of the invention.

FIG. 3 is a block diagram of a particular embodiment of a suitable architecture for remotely diagnosing grid-based computing systems with autonomic diagnostic agents according to embodiments of the present invention.

FIG. 4 is a schematic diagram representing a process according to embodiments of the present invention by which autonomic diagnostic agents utilize rules and metadata configured prior to execution in order to run automatically within a grid-based system.

FIG. 5 schematic diagram illustrating the use of truth functions to determine the actions of autonomic diagnostic agents according to preferred process embodiments of the present invention.

FIG. 6 is a schematic diagram representing the communication flows that occur within a diagnostic architecture by an autonomic diagnostic agent process initialized within a grid-based system by a service engineer according to embodiments of the invention.

FIG. 7 is a flow diagram depicting the steps and inputs of an exemplary autonomic diagnostic agent according to one embodiment of the present invention.

FIG. 8 is a schematic diagram representing how the transition between the various steps of a diagnostic script are managed by a web of states derived from the database of preset rules according to preferred embodiments of the present invention.

FIG. 9 is a schematic diagram depicting the invoking of sequential autonomic diagnostic agent instances according to embodiments of the invention.

FIG. 10 is a schematic diagram representing the interaction and cooperation of various subprocesses initialized for a given autonomic diagnostic agent instance according to preferred embodiments of the present invention.

FIG. 11 is a schematic diagram representing computational and logging activity within a diagnostic execution workspace for an autonomic diagnostic agent instance in an embodiment of the present invention.

### DETAILED DESCRIPTION OF THE PREFERRED EMBODIMENTS

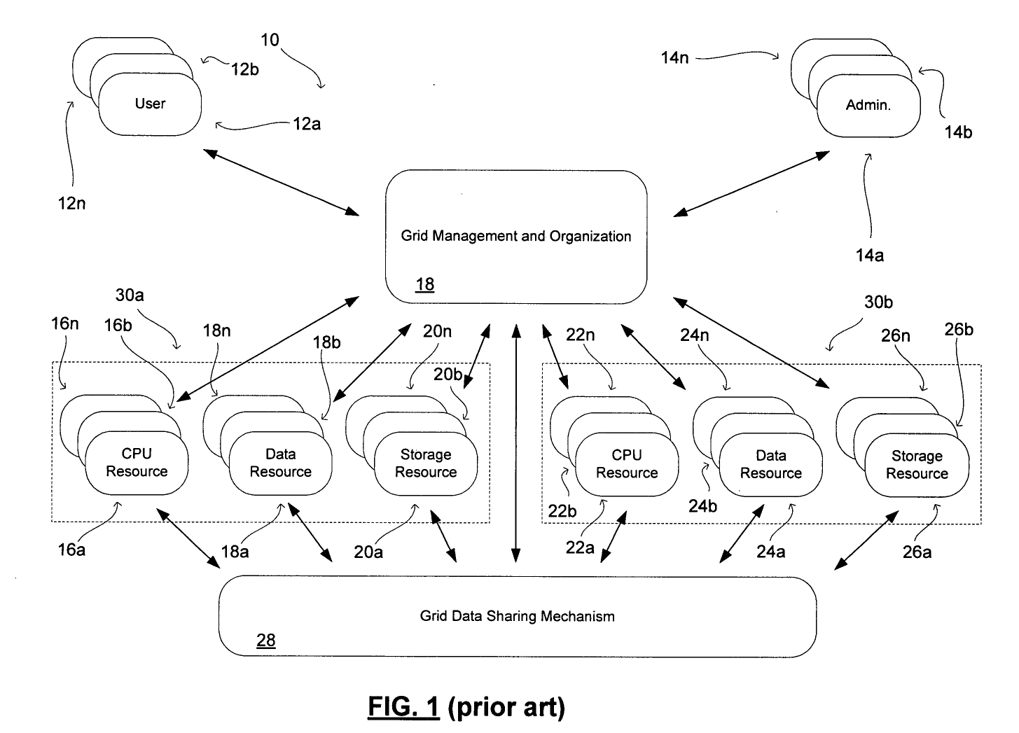

To provide general context for describing the methods and systems for diagnosing with autonomic agents according to the present invention, FIG. 1 schematically depicts a grid-based computing system 10 of the conventional type. The grid-based computing system 10 may include one or more users 12a-12n and one more administrators 14a-14n. A grid management and organization element 16, which allocates and associates resources and sub-systems within the grid, is in communication with users 12a-12n and with administrators 14a-14n. Also in communication with the grid management and organization element 16 is a first set of CPU resources 16a-16n (such as servers), a first set of data resources 18a-18n (such as databases) and a first set of storage resources 20a-20n (such as mass storage devices). The first set of CPU resources 16a-16n, data resources 18a-18n, and storage resources 20a-20n may be collectively referred to as a farm 30a, which could, for example, be located at a first location. A CPU resource could comprise a personal computer, a mainframe computer, a workstation or other similar type device, a data resource may be a database, a data structure or the like, and a storage resource may include magnetic tape storage, semiconductor storage, a hard drive device, a CD-ROM, a DVD-ROM, a computer diskette, or similar type device. Grid management and organization element 16 is also in communication with a second set of CPU resources 22a-22n, a second set of data resources 24a-24n, and a second set of storage resources 26a-26n, which may comprise farm 30b. The resources of farm 30b could be located at the first location with farm 30a, or located remotely at a second, different location. While two farms 30a and 30b are shown, it should be appreciated that any number of farms could be included in the grid-based computing system 10. Further, while CPU resources, data resources and storage resources are shown, other resources, including but not limited to servers, network switches, firewalls and the like could also be utilized.

Grid-based computing system 10 further includes a grid data sharing mechanism 28 that is in communication with the grid management organization element 16 and farms 30a and 30b as depicted. Additional resources and resource types may be added to a farm from an available resource pool (not depicted), and resources may also be subtracted from a farm which may go back into the resource pool. With such an arrangement, a user (e.g., user 12b) can access a CPU resource (e.g. CPU resource 22a) in farm 30a, while also utilizing data resource 24b and storage resource 26n. Similarly, an administrator 14a can utilize CPU resource 16n and storage resource 20a. Further, resources can be mixed and matched to satisfy load/bandwidth needs or concerns or to prevent down time in the event of a resource failure. Grid management and organization element 16 and grid data sharing mechanism 28 control access to the different resources as well as manage the resources within the grid based computing system 10.

Generally, events in a grid-based system that are watched for customers can be very generally sorted into two categories. The first category includes “chargeable” events, which are primarily intended for use by the grid-based computing system for billing end users for usage. In particular, this is how server farms operate under utility computing arrangements, and how the provider of the server farm obtains income for use of its hardware.

The other category of events represent non-chargeable events, such as failures, in the grid-based computing system. For example, when a device fails and is replaced by another device automatically which satisfies the Service Level Agreement (“SLA”) requirements for the end user, one or more events would be generated, including a failure event. A typical self-healing architecture is expected to recover automatically from such a failure. However, it may be necessary to examine the device that exhibited failure symptoms. In particular, a service engineer would need to diagnose and identify the root cause of the failure in the device, to fix the device remotely and to return the device back to the grid-based computing system's resource pool.

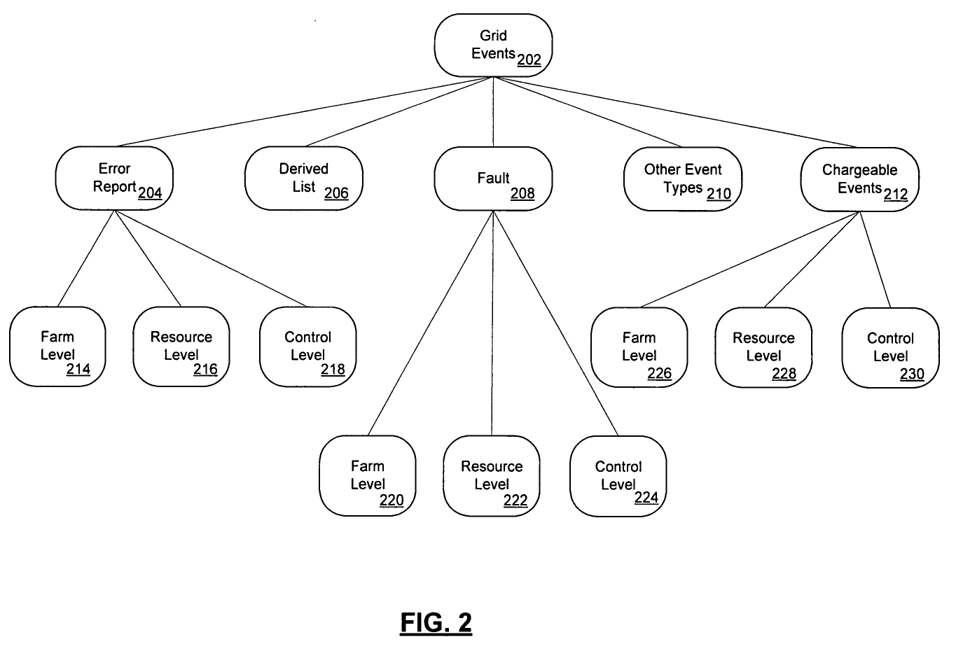

In this regard, embodiments of the invention can utilize a suitable event framework that defines an arrangement of event information concerning a grid-based network by which core categorizes and handles all event records of any type and any related data generated by the grid system. Referring now to FIG. 2, there is depicted an embodiment of a grid event framework 200 within which the autonomic agents of present invention may operate. The framework 200 includes a root node 202, labeled grid events, which can be thought of as including the universe of all events for a grid-based system. The grid events can be classified into different event types, as depicted. These event types include an error report events 204, a derived list events 206, a fault events 208, chargeable events 212, and other events types 210. Error reports 204 (also referred to as error events) are generated upon the detection of an abnormal or unexpected condition, and are recorded in persistent storage (e.g. a file system) where they can be later accessed and reviewed as necessary.

A derived list event 206 can be one result of a diagnostic instance initiated by a RSE and shows one or more suspected failed devices and may also indicate a likelihood value that the device is the reason for the indicated alarm or event. A diagnostic instance to produce such a derived list typically would be launched by a RSE through the user interface after learning of a fault event.

A fault event 208 is an imperfect condition that may or may not cause a visible error condition (i.e., an unintended behavior). A particular fault may not actually cause an unintended behavior; for example, a sudden drop in performance of a segment of a computing system covered by a specific set of virtual local area networks (VLANs) could result in an error message. Fault management is the detection, diagnosis and correction of faults in a way to effectively eliminate unintended behavior and remediate the underlying fault. Autonomic diagnostic agents according to the present invention are adapted particularly for analysis and remediation of fault events.

Chargeable events type 212 are as described above, and other events types 210 refer to events which are not an error report, derived list, fault or chargeable event.

The fault event 208 type, as well as error report 204, and chargeable 212 types, further can be classified as depicted as including three sub-types: farm level, resource level and control level events. Thus, events within these type categories may be segregated further into these sub-categories as appropriate (depending upon their origin level). Additional sub-categories can sort events in terms of their criticality level (e.g., critical, non-critical, and warning). These various categories could be useful for organization and management, such as for priority handling or for presentation via the diagnostic telemetry interface to the user interface.

For example, three primary farm level events that are monitored can include: when a farm is created, when a farm is deactivated and when a farm is dysfunctional. Similarly, resource level events can include various occurrences such as those itemized in Table 1 below.

TABLE 1

| Device Event | Definition |
|---|---|
| add | When a device (such as a server) is allocated |
| avail | When a device is made available for usage; for |
| | example, a server allocated and brought online |
| | in the resource pool |
| fail | When a device fails; e.g., a switch stopped |
| | forwarding data packets |
| del | When a device is un-allocated; e.g. a directory |
| | server brought down for hardware maintenance |
| add | When a device is restored; e.g. a firewall is |
| and avail | reactivated and it has started filtering |
| | network traffic |

Examples of devices that can be resources include, but are not limited to, load balancers, firewalls, servers, network attached storage (NAS), and Ethernet ports. Other resources to be monitored include, but are not limited to, disks, VLANs, subnets, and IP Addresses.

Utilizing the selected event framework, such as the one depicted in and described with respect to FIG. 2, a user, such as a remote service engineer, is able to associate a resource level event with a farm event through the user interface, since each farm level event detail has a farm ID included in it and the resource level event also has an associated farm ID. For example, if a service engineer is trying to investigate a firewall failure event, the farm ID for that failed firewall device can be traced to the farm level events for that ID. Further, all the farm events for that farm can be examined to see if any one of them could have a possible relation to the failure of that specific firewall. Next, FML (Farm Markup Language), WML (Wiring Markup Language) and MML (Monitoring Markup Language) can help in the configuration and physical connectivity analysis respectively.

In a grid-based computing environment, events can refer to the resource layer (“rl”), the control layer (“cl”), or the farm-level (“fl”). In a particular embodiment of the invention, it is preferred that event messages (also referred to as event records) have a common format, include a time, a sequence number and details of the event. An example shown in Extended Backus Nauer Form (EBNF) is:

<event-message>:: = <utc-date-time> <sequence-info>
<event-info> “ ” <event-details>
<event-info>:: = “event” “=” <event> <event>:: =

“resource” | “control” | “farm”

<event-details>:: = <rl-event-desc> l <cl-event-desc> | <f-event-desc>

Events have a sequence number that uniquely identifies the event within a given fabric. The definition of a sequence is as follows (in EBNF):
<sequence-info>::=“seq” “=”<fabric-name>“:”<sequence-id>

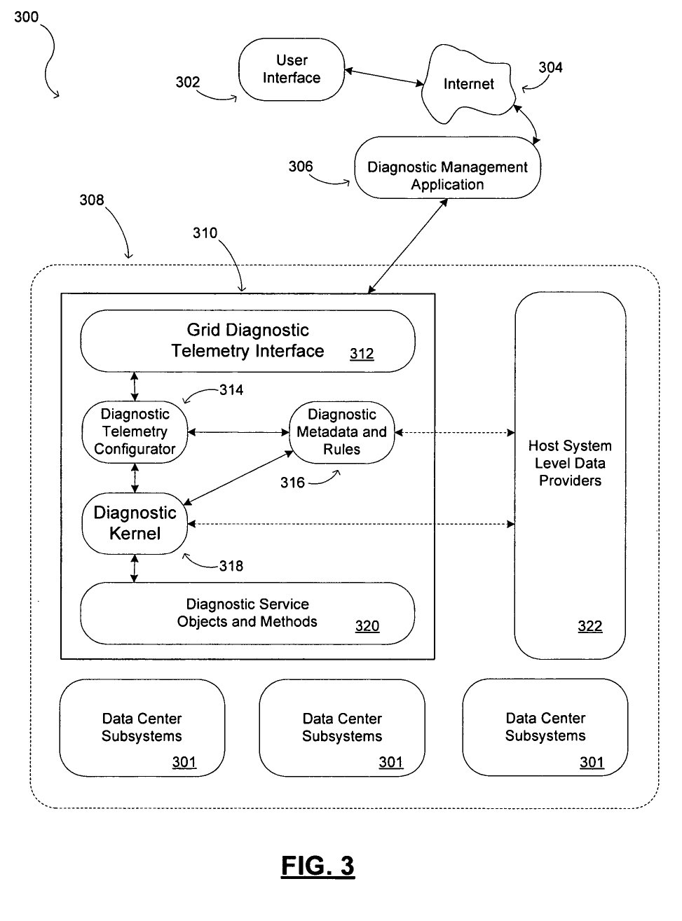

It will be readily appreciated by one of ordinary skill in the art that the event records that are applied to the event framework to identify one or more resources which caused the event in the grid-based computing system are generated by monitors and devices running within the grid based system. Data providers, as described and depicted below with respect to FIG. 3, for example, could accomplish monitoring at the host level, while grid level monitoring could be performed by a conventional monitoring system of the grid-based computing system itself. The monitoring system of the grid-based computing system performs several roles, which may include monitoring the health of equipment in the resource layer, monitoring the health of equipment in the control layer, providing a mechanism to deliver event logging throughout the ID, and providing a mechanism to deliver event logging to a third party Network Management System (NMS).

Autonomic diagnostic agents according to the present invention are processes or instances spawned within the service interface architecture for a grid-based system, and these autonomic diagnostic agents employ rules engine logic. This logic follows a series of commands that operate on metadata, including telemetry and event information and data in particular, according to a set of rules previously established by an administrator. The autonomic diagnostic agents, when initialized by a service engineer, therefore execute commands according to the rules and based on the facts and data found in the grid-based system, and then makes an educated determination about the grid. In certain cases, a particular autonomic diagnostic agent could take certain remedial actions, such as returning an offline or failed resource to a resource pool or rebooting a device.

FIG. 3 depicts an example of a suitable service interface architecture 300 of a grid-based computing system, such as the grid-based computing system 10 described in FIG. 1, which architecture 300 could be used to provide remote diagnosis capabilities via autonomic diagnostic agents according to the present invention. Employing architecture 300, a service engineer can invoke a utility through the user interface 302 to remotely execute commands in the customer's grid environment and to remotely examine behavior of a web service (consisting of several related applications) or of a single application running in the grid environment. Preferably, the utility would allow the RSE to share the execution view and control with users (customers) who own the application environment within the grid. Information at the time of failure of any computing resource or entity is particularly helpful for troubleshooting purposes. In conventional operation of a grid-based computing system, upon an indication of failure event, a failed device in the resource pool is replaced with another available device. Therefore, in a particular embodiment of remotely diagnosing a grid-based computing system, when a device fails, the failure details are exported to a control panel of the virtualized data center 308 where it thereafter can be reported to the appropriate service engineer via the Diagnostic Management Application 306 and the user interface 302. Employing such an architecture 300 according to the present invention enables a service engineer to invoke a utility through a suitable user interface to remotely execute commands in the customer's grid environment and to remotely examine behavior of a web service (consisting of several related applications) or of a single application running in the grid environment.

As described generally above, the user interface 302 (also referred to as a front-end) is accessed by a user desirous of performing diagnostic procedures, such as a remotely located service engineer (i.e., an RSE). The user interface 302 provides communication across a network, e.g., Internet 304, to access a diagnostic management application 306 which is resident on the grid-based computing system. Preferably, communication across the Internet is performed using a secure tunnel architecture to maintain integrity and privacy of client data. The user interface 302 as depicted allows a user in one location to communicate with any number of grid-based computing systems located remotely from the user. The user interface provides the service engineer with the ability to focus in on a customer's location, a customer's grid-based computing system and the associated event framework to receive and review relevant events, alarms and telemetry information. The user interface further allows the user to select the primary grid-based computing system entities, such as farm or resource, or a subsystem within a farm or resource, for examination. As such, the user interface can display trouble areas and display events that are critical (or otherwise notable), and generally enable the user to review data, draw conclusions, and configure and launch autonomic diagnostic agents as described herein.

Using the interface, the user is able to collect information from the grid-based computing system pertaining to server farm and resource level events and error conditions, configuration information and changes, utility reports at farm and resource levels, status information, and asset survey and asset “delta” (i.e., change) reports. In operation, for example, a support line of remotely located service engineers can be contacted by a client of the grid-based network, such as via telephone, email, web client, etc., for assistance in diagnosing and/or remedying a particular network fault or other event. A remote service engineer in response would then utilize the user interface 302 to address the inquiry of the client by examining the status of the particular farms, resources, and subsystems implicated by the event.

In conventional operation of a grid-based computing system, upon an indication of failure, a failed device in the resource pool is replaced with another available device. Therefore, it should be appreciated that when a device fails, failure details are exported to a virtualized data center control panel, which ultimately leads to information concerning the failure being reported to a service engineer. As noted above, a service engineer faced with a troubleshooting task in light of a failure event needs to understand the high level abstract view presented by the grid-based computing system and its allocation/un-allocation/reallocation and other provisioning abilities, as well as be able to drill down to collect information from a single resource level such as a server or a network switch. Thus, in embodiments of the invention, the user interface provides a service engineer with the capability to lookup the status of various resources linked to an event, and then obtain and review any telemetry data and metadata produced by the grid-based system in relation to the resources and event.

Additionally, as will be described further below, the user interface also enables a user, such as an administrator and/or service engineer, to configure telemetry parameters based on the diagnostic metadata, such as thresholds which in turn enable faults messages or alarms when those thresholds are crossed, to configure diagnostic rules, and to remotely receive and make decisions based upon the fault messages, alarms, and telemetry data. Further, the user interface allows a user to monitor the diagnostic data and information received and initiate automated or semi-automated diagnostic services instances in light of certain events, and, in particular, to launch autonomic diagnostic agents and processes that automatically collect information and address problems raised by such events.

In certain embodiments of the invention, the user interface for the remote service engineer can be adapted to provide a simultaneous, side-by-side, or paneled view of the structure and devices of a selected farm along with diagnostic, status, and/or telemetry data concerning those devices. The selection and implementation of one or more of such views is not critical, and could be made in consideration of ergonomic, usability and factors by one of ordinary skill in the art.

Co-pending and co-owned U.S. patent application Ser. No. 10/875,329, the specification of which is herein incorporated by reference in its entirety, discloses a series of suitable user interface screens that could be provided by such a user interface to enable a service engineer user to drill down through a representation of the grid-based system to identify affected resources, subsystems, etc., for a given fault or other event. In this regard, a service engineer could be permitted to select a company (customer) from a list of companies, and then be provided with a list of grids that are being managed for that company. If a particular fault event has occurred that is affecting one of those grids, then, for example, an indication (such as color coding or a message) can be provided. The service engineer can thereby click on the desired/indicated grid to see all the events and alarms relating to that grid, and click to drill down further to determine the cause of the event. When the user clicks on the highlighted grid, the user is taken to a screen showing the farms within the selected grid, which farms in turn can be provided with similar indications. Alternatively, the service engineer can be provided with a screen that indicates the occurrence of faults or events of interest for the selected farm. From either of these screens, particular resources and devices relating to the event/farm can be accessed. The user can thereby access information concerning the subsystems included in the selected network resource. This interface thus enables a service engineer to go through the farm level-by-level in order to diagnose the cause of the event or alarm, and decide upon a course of action.

In a particular embodiment of the user interface, additional information may be shown such as the farm-resource-control layer, or device, or subsystem related telemetry data which may prove useful in performing diagnostic evaluations. Corresponding telemetry data viewing may also be enabled at the respective level of the user interface. For example, when looking at farm-resource-control layers, telemetric parameters at that level may be particularly relevant. Similarly when focused on a device, such as a directory server, telemetry data pertaining to commands such as “sar” (system activity report) or “vmstat” (virtual memory statistics) may be found to be more useful.

The diagnostic management application 306 as depicted in FIG. 3 functions as a web server that provides information to the user interface 302 from the grid based computing system. A Data Center Virtualization architecture 308 for the grid-based computing system as depicted can be used to manage the grid-based computing system as a single system instead of as a collection of individual systems (such as Data Center Subsystems 301). A typical data center virtualization architecture provides intelligence, management, and control features to maintain a highly integrated Ethernet environment that manages configuration and activation of resources, monitoring of resource failures and flexing and recovery of resource usage, and image and physical management of the various resources that comprise the grid system. In this regard, Data Center Virtualization architecture 308 would be a means to enable the grid-based system to, for example, define one or more logical server farms from among the total pool of available resources.

Architecture 300 as depicted in FIG. 3 also includes a grid diagnostic core 310, which in turn includes a Grid Diagnostic Telemetry Interface 312, a Diagnostic Telemetry Configurator 314, a repository of Diagnostic Metadata and Rules 316, a Diagnostic Kernel 318, and a Diagnostic Service Objects and Methods software library 320. Diagnostic Kernel 318 is used to facilitate the fault management at the individual nodes or resources within the grid-based computing system by the spawning and managing of various diagnostic processes and subprocesses, including autonomic diagnostic agents as will be described in more detail below. The Grid Diagnostic Telemetry Interface 312 is in communication with the Diagnostic Telemetry Configurator 314, and is used to provide grid related data to the Data Center Virtualization architecture 308. The Diagnostic Telemetry Configurator 314 in turn is in communication with the Diagnostic Metadata and Rules 316 and with the Diagnostic Kernel 318, and is used to provide metadata parameters to one or more Data Providers 322, and parameters and rules to Diagnostic Kernel 318. These parameters and rules are part of databases or database files defined and populated by the user through the user interface 302, and these parameters and rules define various aspects of the operation of core 310 and any instances of autonomic diagnostic agents that it creates, as described in more detail below.

Data Providers 322 are typically utilized in grid-based systems to supply data from host systems for resolving problems at the host level, and often can therefore be considered resources within the grid domain. Such data providers can include systems statistics providers, hardware alarm providers, trend data providers, configuration providers, field replaceable unit information providers, system analysis providers, network storage providers, configuration change providers, reboot providers, and the like. The Diagnostic Metadata and Rules 316 is in communication with Data Providers 322, and is used by an administrator to configure telemetry parameters (based on the diagnostic metadata) such as thresholds that in turn enable alarms when the thresholds are crossed by data coming from the Data Providers 322. These Data Providers 322 supply relevant information into the service instances initiated by the Diagnostic Kernel 318 as appropriate, and utilize metadata whose parameters are configured by administrators through the user interface 302 via the Diagnostic Telemetry Configurator 314.

As depicted, the Diagnostic Kernel 318 is also communicatively linked with the Diagnostic Service Objects and Methods software library 320, and is used to launch diagnostic service instances that receive relevant information from Data Providers 322. According to embodiments of the invention, a diagnostic service instance started by the Diagnostic Kernel 318 comprises an autonomic diagnostic agent instance via Diagnostic Service Objects and Methods library 320 to address the faulted condition. The Diagnostic Kernel 318 also sends diagnostic telemetry information via the grid Diagnostic Telemetry Interface 312 to the user interface 302.

The present methods and systems for remotely diagnosing grid-based computing systems thus utilize a suitable architecture such as architecture 100 to provide a service interface to the customer's grid-based computing system environment, and with it the ability to examine entities within those computing systems and the ability to initiate automated diagnostic procedures (using diagnostic metadata and rules) or collect diagnostic related data for analysis and resolution of the problem.

In this regard, RSEs are assisted in remotely identifying problems by deploying autonomic diagnostic agents according to the methods and systems of the invention, which autonomic diagnostic agents identify causes or potential causes for problems, and, in certain instances, automatically resolve the problem or provide automated assistance to the user for resolving the problem. Alternatively, the autonomic nature of the diagnostic agents can be disabled to instead provide the service engineers with, for example, suggested step-by-step commands for diagnostic processes for generating a derived list of suspect causes that are candidates for causing or leading to a subsystem fault—either at the grid-based computing system farm-resource-control layer or at the host subsystem level. This alternative option would thereby allow a RSE to step through the diagnostic algorithm embodied by a particular autonomic diagnostic agent and its corresponding scripts and subprocesses.

Autonomic diagnostic agents can be comprised of a list of tasks, such as a script of commands or function calls in an operating system language or object code language, invoked automatically via other scripts or initiated by a RSE for deciding on diagnosis for a section of a data center under question when a particular event is encountered. Each such agent can be considered stateless in that it will not pass on information from one instance to the next instance of the same or another agent. The operation of any given autonomic diagnostic agent, however, is predicated by a data store of rules (e.g., stored in a database of diagnostic metadata and rules 316 in architecture 300) that define the logical relationships of all the resources, subsystems and other elements within the grid-based system and define what kind of metadata and telemetry data is created, monitored, and/or utilized in management of the grid-based system.

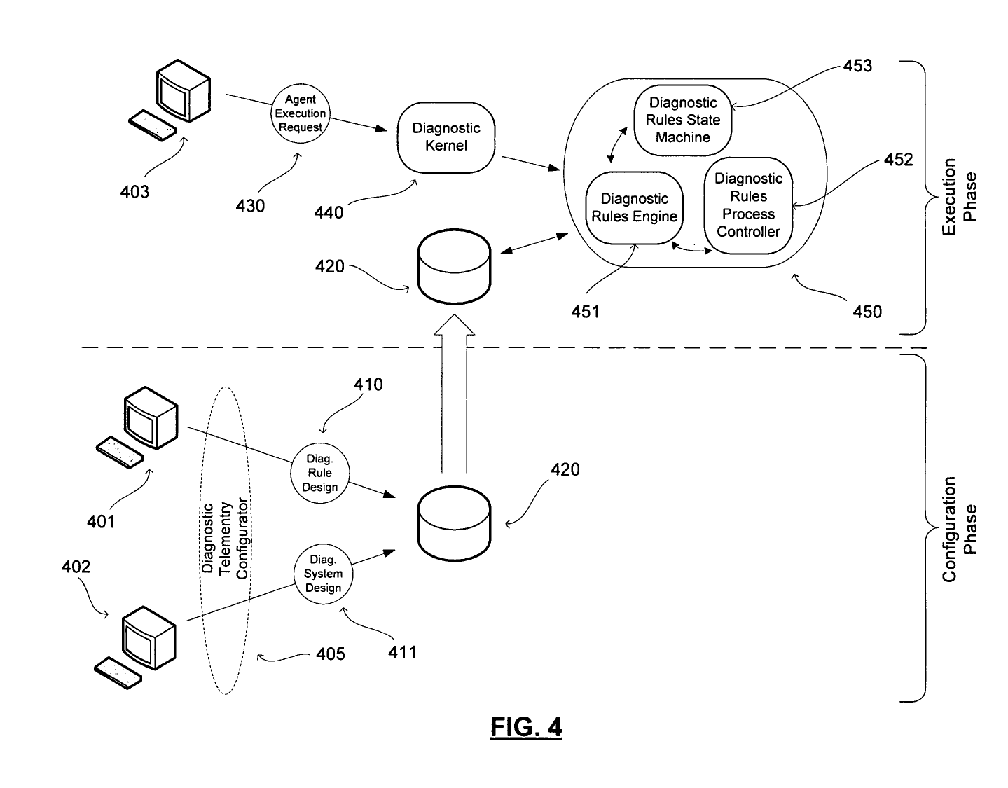

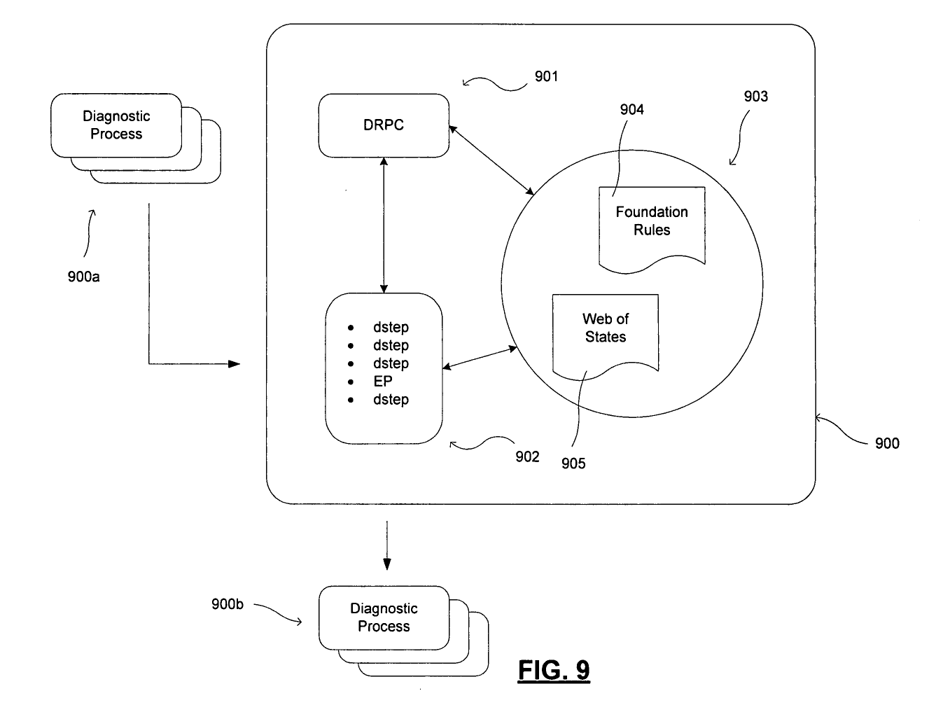

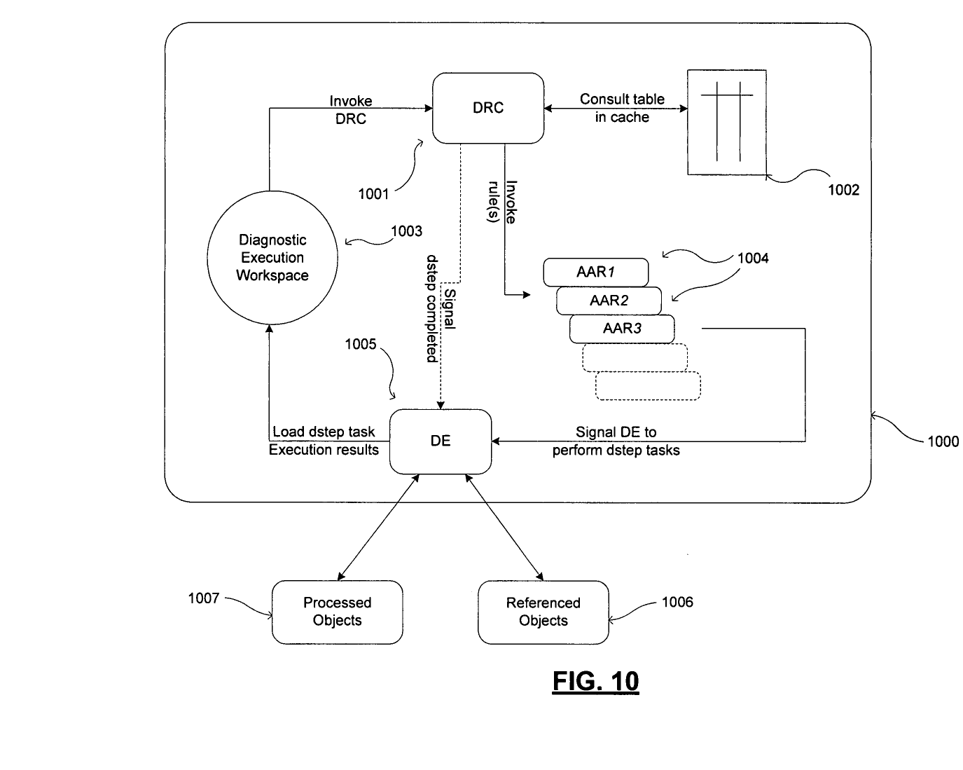

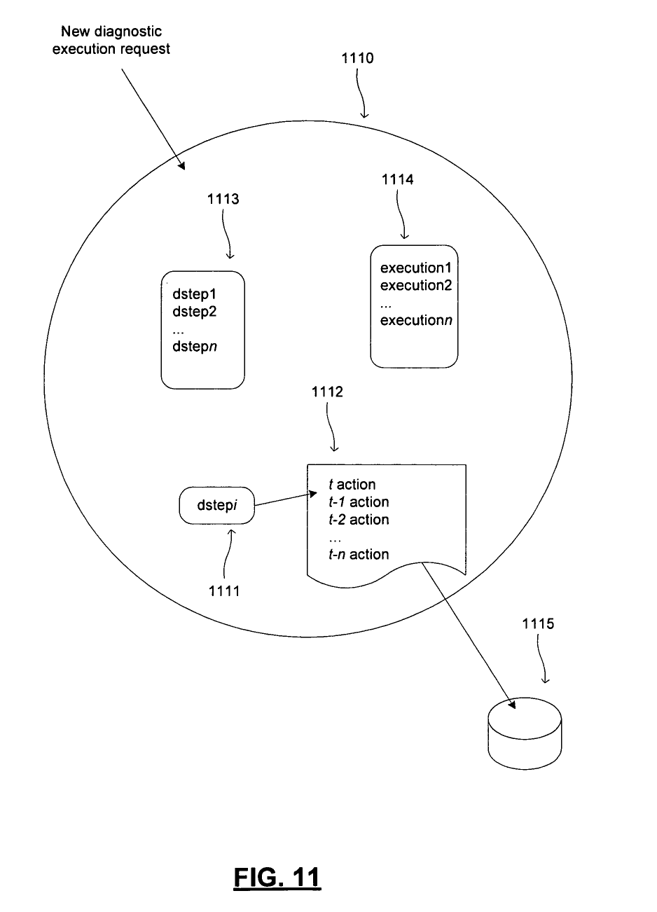

FIG. 4 depicts how diagnostic agents, also referred to herein as diagnostic service instances, are processes that are largely dependent upon a set of rules, established and controlled via the diagnostic telemetry configurator (labeled 314 in FIG. 3), that are particular to a given grid-based network. The diagnostic agents may be launched on demand by a RSE and will run in at least partially automated fashion as described below to, for example, isolate down to a suspected device or, produce a derived list of suspected areas of failed subsystems. As illustrated in FIG. 4, a particular instance 450 of an autonomic diagnostic agent will comprise a diagnostic rules engine (“DRE”) 451 spawned by the diagnostic kernel daemon in response to an initiate agent command received from a RSE via the user interface. The DRE is a process that governs an entire instance of a particular autonomic diagnostic instance from initialization to completion. The DRE 451 in turn spawns a diagnostic rules process controller 452 subprocess and a diagnostic rules state machine 453 subprocess, which subprocess interact with the DRE and with one another. The diagnostic rules process controller 452 describes and manages the activities that make up the autonomic on-demand diagnostic process, which activities, in turn, are defined and ordered as dsteps, which are organized into a dscript. Each autonomic agent has one or more corresponding dscripts. These dstep tasks are invoked in a controlled fashion by the diagnostic rules process controller 452 subprocess, while the diagnostic rules state machine 453 subprocess establishes the state-transition rules for moving between the dsteps based on the database of compiled rules as they relate to the dscript under execution by diagnostic agent instance. The diagnostic rules state machine 453 subprocess applies these state transition rules to manage task of individually monitoring the completion of each dstep. The operation and interrelation of the diagnostic rules process controller 452 subprocess and the diagnostic rules state machine 453 subprocess in certain preferred embodiments of the present invention is described in detail below with relation to FIG. 9, FIG. 10 and FIG. 11.

Conceptually, each dscript may be considered roughly equivalent to a list of functions, such as a script of generally sequential commands or function calls described in an operating system language or object code language. In this analogy, an individual dstep would then generally correspond to a single command or function call within the script. The dscript thereby lays out a series of diagnostic computing actions that are appropriate to the current combination of grid configuration and event type, which actions can be invoked automatically via other scripts or initiated by a RSE for deciding on diagnosis for a section of a data center under question when an event is encountered.

Particular dsteps that correspond to more complex function calls, as opposed to relatively more simple commands or command line operations, may be invoked by the diagnostic rules process controller 452 as a subroutine termed an Event Processor (“EP”). The purpose of EPs is to manage units of execution work within a dscript as a result of event occurrences (where events are part of the event framework in the context of the data center virtualization, such as described above in the example of FIG. 2). EPs operate like mini dscripts by managing units of work represented by a collated sequence of one or more steps. EPs are invoked as a result of exceptional event occurrences, e.g., a fault that results in an error condition. EPs are notable in that they are managed consistently and independently from the other dsteps, such as by a distinct thread execution or as a separate sub-process spawned by the dscript.

EPs could be of different implementation forms depending on the operating environment. In the UNIX or LINUX operating systems, they could be implemented as threads that run asynchronously, while in others they could be asynchronous traps. Regardless of their particular means of implementation, one of ordinary skill in the art will appreciate that such EPs will be useful as reusable subroutines that could be invoked by a number of different dscripts. EPs thus are invoked as appropriate by an active instance of an autonomic diagnostic agent during execution. EPs according to preferred embodiments of the present invention can be classified as being an exception processor or synchronization processor.

For example, in an interactive execution of an agent (where a RSE is involved actively in making a decision sometime during agent execution), an exception processor could be invoked to cause the display of an appropriate level of graphic information in a window to the user, wait for a response, and resume or terminate when one or more valid responses are received. For a warning on a farm device such as a firewall that comprises an exception within the operable framework, an exception processor can be utilized by a related dscript to present a question to the RSE asking if the diagnostic execution should be continued in the direction of the warning (so as to isolate the fault). The RSE may or may not want to go deeper into isolating the cause for the warning because, for example, the firewall for the farm in question may be still filtering incoming IP packets but be advising on oversized packets. In such a situation, the RSE could suspect that a buffer overflow attack is the cause of the oversized packets, and therefore the RSE may want to address some other issues first.

Synchronization processors, conversely, are used to coordinate requests and responses between multiple processes of an instance. This coordination could be in synchronous or asynchronous fashion. In certain circumstances, two dsteps or event processors consulting different rules and metadata may need to be executed simultaneously in order to arrive at a diagnostic conclusion because, for example, they run asynchronously on two separate parallel processors of a 2-way server device. Similarly, a delayed execution of one dstep or event processor may need to be synchronized with the completion of execution and return of a result from another dstep or EP.

Rules as utilized by the autonomic diagnostic agents according to embodiments of the invention are a special kind of object produced by rule designers for the diagnostic metadata & rules repository. The repository for the diagnostic metadata and rules, as depicted in FIG. 3, should be maintained minimally separated from the diagnostic execution environment (diagnostic kernel, instances, etc.) to enable interaction of the diagnostic kernel and its spawned DRE with the repository during execution. The rules in the repository are defined as software objects. During execution of an autonomous diagnostic agent according to embodiments of the present invention, relevant rules are utilized by a diagnostic agent instance for fault diagnosis and isolation at various points throughout a given dscript. According to embodiments of the invention, there are at least four different primary types of rules that will interact in the context of an autonomic diagnostic agent and within the framework and architecture described above, namely diagnostic process rules (“DPR”), agent action rules (“AAR”), granular diagnostic rules (“GDR”), and foundation rules (“FR”).

DPR are specific to a product, which may be a device or subsystem in the data center. They are defined at design time, a priori, by product design and service personnel who have successfully diagnosed the product. A DPR can comprise, for example, a rule establishing standard procedures for diagnosing the booting of a particular brand and model of web server as provided by the producer of the web server. These standard procedures could dictate, for example, that you first check the memory, then check certain processes, and so on.

AAR are consumed at the execution level and are organized according to the dsteps to which they apply, and also according to the execution category to which they belong. An AAR is a rule that specifies a course of action associated with the completion of a particular dstep or EP. Execution categories fall into setting various levels of errors (critical, non-critical and warning), re-routing execution and exiting under exceptional conditions, etc.

GDR are similar to DPR except that they are specific to a device or subsystem and are more granular compared to DPRs. For example, within a server device (governed by a DPR), one or more GDR may be specifically defined to apply to, for example, a storage sub-device, or to a set of sub-devices which are central processing units. GDRs typically focus on diagnostic characteristics of a sub-device and its finer components. A single DPR at a device or subsystem level may, in fact, activate multiple GDRs depending upon the path of the diagnostic agent execution and predicate results at decision points within that patent at sub-device or sub-sub-device levels. For example, a failure of a device as defined by a device level rule may lead to further rule checking using appropriate GDRs at the device's sub-device level.

FRs are insulated from the agent execution environment, and typically would be defined in such a way that they can be modified and reused. The dsteps executed within the rules engines of the diagnostic agents consult FRs. The rules of this type represent rules that can be commonly defined across a family of products. They are less likely to change frequently as the products go through their life cycle of development, deployment, upgrades/downgrades and end-of-life. Because of their lesser interdependencies (between different product types with a family of products) they will be relied upon for consistency and often referred to at the dstep level. Taking the example of a firewall device to illustrate, a family of stateful firewall filters at the IP (Internet Protocol) level have an operating system kernel resident driver. A diagnostic rule of the FR type could establish that a dscript should always check if the filter module is kernel resident and active if the firewall is not filtering incoming traffic.

The rules utilized in embodiments of the invention can also include combinatorial rules (“CR”) that are based on two or more rules of the above four primary types. Two similar types or differing types can form a CR. CR is a direct result of simple conjugation with predicates. A typical example of a combinatorial diagnostic rule could be represented as:
{if interface ge01 is down & server053 is up} {then run command config0039}

where config0039 is defined as “ifconfig-a” in the rules repository.

In the above example, the outcome of two GDRs have been combined into a rule that tests if the gigabit interface ge01 is up and if the UNIX server server053 responds to ping, then conditionally indicates that the configuration command config0039 should be run.

Further, derived rules (“DR”) for every primary type of rule is possible, either as a result of explicit conjugation or using advanced knowledge of one or more of the resource elements under question. Derived DPR, AAR, GDR and FR can enhance flexibility with advanced predicates supplanting complex logic combinations. Typically, the design and encoding of derived rules as described herein would be undertaken by senior service engineers who are thoroughly knowledgeable about the resource elements and have tested advanced implications of deriving a rule from two or more primary rules for those elements.

Notably, the rules according to preferred embodiments of the invention are flexible as they are defined as software objects. Sometimes, the control and interface activities are resident in one rule. Control and interface activities must be separated into different objects so versions of controls and interfaces can be kept. For example, a small subset of rules for a network switch generated from DPRs, AAR, GDRs and FRs and may look like this:
NS21: configure ports 9, 10, 12, 14
NS26: monitor ports 12, 13, 14
NS29: connect port 9 to firewall input port 1

If the first two rules are considered as “control” related, the last one can be considered “interface” related and hence involves information pertaining to the entities external to the switch. The switch may change and the firewall may be redesigned to have multiple input ports. By encapsulating rule NS29 into a separate object, its variations over a period of time can be tracked. Rule NS26 is related to external monitoring although there are no external elements explicitly included in the rule. In this regard, it is likely that an AAR would be defined to make use of these FRs for the switch.

Autonomic diagnostic agents according to these preferred embodiments of the invention comprise software driven rules engines that operate on facts or metadata, such as telemetry and event information and data, according to these four primary rule types and those rules derived therefrom. The autonomic diagnostic agents therefore execute in accordance with the rules based on the facts and data found in the grid-based system, and then makes a determination about the grid. As described above, rules according to the present invention are defined as software objects which are stored in a repository, such as a database, of diagnostic metadata and rules (such as element 36 of FIG. 3). The autonomic diagnostic agents perform a series of steps or operations (“dsteps”) that are defined by a particular dscript. As the operations of a particular dscript must vary depending upon the status and configuration of the particular grid-based system being diagnosed, each autonomic diagnostic agent bases its operations and decisions upon the rules, as defined by the appropriate diagnostic metadata and rules database for each grid-based system.

Referring now back to FIG. 4, there is depicted schematically the mechanism according to embodiments of the present invention by which autonomic diagnostic agents rely upon rules and metadata configured prior to execution by rule designers and system and service engineers to run automatically to either diagnose the possible root cause(s) of faults, errors, or other events of interest, and in certain cases to take appropriate remedial actions. As shown in the drawing, a diagnostic rules designer 401 can utilize an application in the service interface, which application interacts with the diagnostic telemetry configurator 405 (also represented as element 314 in architecture 300 of FIG. 3), to design one or more diagnostic rules 410 for a particular grid-based system. These diagnostic rules are stored in the diagnostic metadata and rules database 420 for the grid-based system. At the same time, a system engineer or RSE can interact with the diagnostic telemetry configurator 405 to design one or more diagnostic rules 410 for the particular grid-based system to store metadata and other configuration information 411 in the diagnostic metadata and rules database 420. Rule designers, service engineers and RSEs do these configuration phase steps whenever a particular grid-based system needs to be initially configured for monitoring within the diagnostic architecture, framework, and agents according to the present invention, or whenever a previously configured grid-based system has been modified (e.g., a new logical server group, comprising newly installed hardware and/or existing hardware, is configured) in a manner that would affect diagnostic capabilities.

At any point after a grid-based system has been initially configured by creating the diagnostic metadata and rules database 420, a user, such as a RSE 403, can utilize the execution phase elements of the diagnostic management application. As described above, a RSE user can view events produced by the grid-based system via the diagnostic management application and cause autonomic diagnostic agents to be executed within a desired grid-based system during this phase. When an event occurs for which the RSE believes an autonomic diagnostic agent would be useful (such as a firewall error), as depicted in FIG. 4, the RSE sends a request 430 via the service interface to initiate that desired autonomic diagnostic agent within the grid system. This request 430 is received by the diagnostic kernel 440 daemon in the grid-based system (also represented as element 318 in architecture 300 of FIG. 3), and the kernel thereafter spawns an autonomic diagnostic agent daemon 450. This daemon 450 includes the diagnostic rules engine (“DRE”) process 451 and the diagnostic rules process controller 452 (“DRPC”) and diagnostic rules state machine 453 (“DRSM”) subprocesses, with which it interacts. The DRPC describes and centrally manages the activities which make up the autonomic diagnostic agent's process. As noted above, these activities are defined and ordered as dsteps which are organized into a dscript, and the dsteps are invoked by the DRPC. The DRPC may invoke a set of subordinate event processors as subprocesses to manage units of execution work within a dscript, such as in response to the occurrence of particular events as defined by the appropriate event framework. The DRSM subprocess loads the state-transition rules that establishes how the daemon moves between the dsteps and EPs of the relevant dscript.

The DRE utilizes the DRSM to obtain the necessary rules information from the diagnostic metadata and rules database 430 at the beginning of a diagnostic agent instance, providing the autonomic diagnostic agent daemon 450 with a diagnostic execution workspace that is fully customized to the then current status and configuration of the particular grid-based system. The agent daemon 450 then proceeds according to the dsteps set out by the dscript, which may include retrieving and analyzing telemetry data from the data providers (element 322 of FIG. 3) and other systems of the grid, and taking corrective actions. The DRE 451 generally proceeds through the steps of the invoked dscript as dictated by AARs. Each time a dstep is completed, the DRPC 452 is called, and the DRPC 452, in turn, selects and invokes the next appropriate AAR. When all dsteps, EPs and AARs have passed a return to the DRPC, the DRPC then signals completion of the diagnostic on-demand agent (invoked automatically or by a RSE). Typically, the corrective actions taken by an autonomic diagnostic agent according to the present invention would be relatively simple actions, such as restarting a dead daemon, that are considered by the rule designers to be safe and innocuous.

In this manner, so long as the diagnostic metadata and rules databases are maintained to accurately reflect the status and configurations of their respective grid-based systems, a service engineer could initialize the same diagnostic agent dscript whenever a particular event or scenario of events is encountered in any one of the grids with the confidence that the dscript in question will operate the same in each environment and will not have been broken by any changes or reconfigurations to any of the grid-based systems.

AARs as consulted by the DRPC can be represented as truth function tasks that derive the parameters they need from processed objects and then supply those parameter values to other rules, such as FRs, to determine the truth value of their predicates, or “antecedents”, and, if true, execute their specified results, or “consequents”. These truth functions are defined in a manner such that they inherently know what metadata and other parameters are necessary to determine the truth values, and to know where to find the values of these parameters among the diagnostic objects and workspace of a given architecture.

Preferably, the AARs relevant to a particular autonomic diagnostic agent are organized by the DRPC according to the dsteps and EPs to which they apply, and also according to their action type. The action type of an AAR describes how the consequent (i.e. the result) affects the diagnostic process. Action types can include: identifying fatal errors, identifying correctable errors, identifying warning conditions and setting them, obtaining approvals or re-routing from other diagnostic processes, and re-routing executions to other diagnostic processes. Action types must be ordered, according to the degree of severity, to ensure that the diagnostic system does not perform meaningless work, and to avoid unexpected side effects as the system is modified.

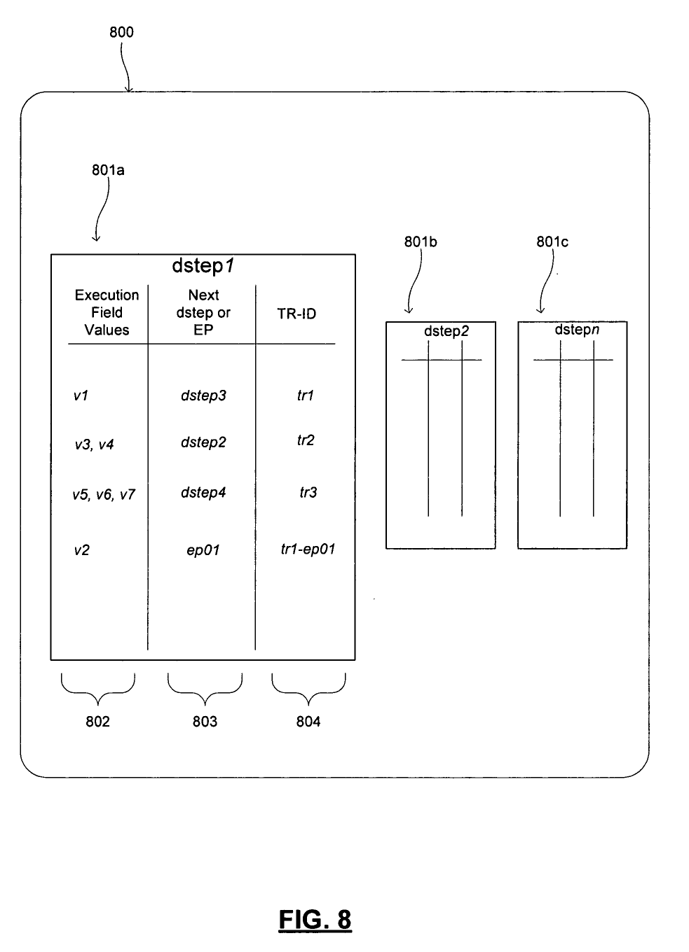

When an AAR is invoked by the DRPC, the DRPC uses the rule to establish the truth values of its antecedents. The dstep must access some attributes of the object(s) it is trying to diagnose. As values relating to a processed object are evaluated, the dstep causes a DRE daemon to consult an appropriate FR to determine the import of the current metadata parameters relating to the object. In consulting these FRs, the truth function of the dstep is initiated as a local task within the diagnostic execution workspace that is able to obtain the appropriate parameter values in the given environment and invoke the proper FR, and then evaluate the result to produce a truth value that is then returned to the requester. Notably, truth functions provide considerable code re-use, and also insulate dstep from the knowledge of the parameters required or the services provided by the FR. The return value of the truth function might give rise to a warning or an automated adjustment within a dstep, or execution direction to a different AAR after the dstep completion, as illustrated below with respect to FIG. 8.

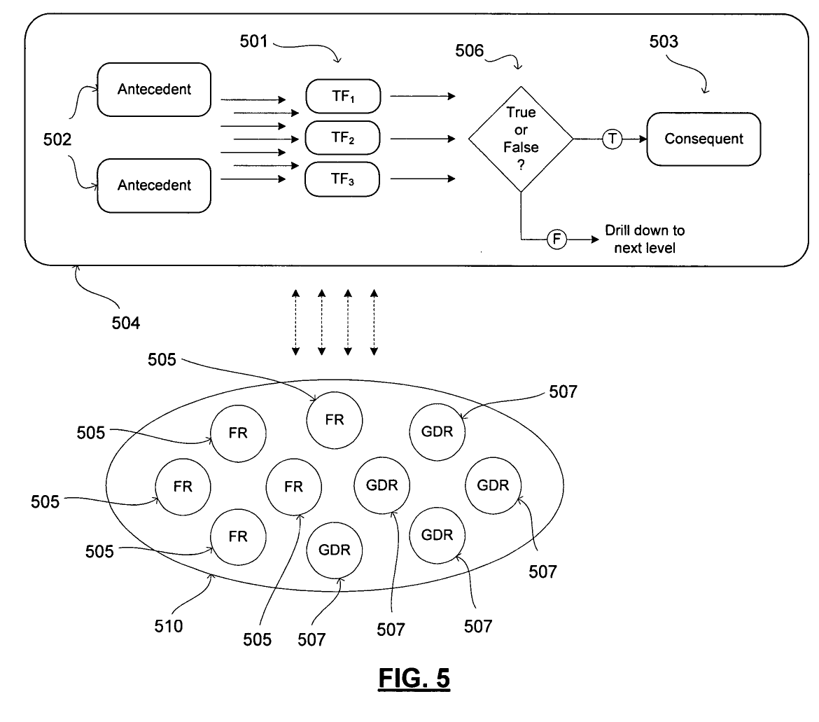

FIG. 5 schematically depicts the use of truth functions 501, and related antecedents 502 and consequents 503, by the DRPC according to these embodiments of the invention. Each antecedent 502 of the truth functions 501 for the AAR 504 in question is invoked in parallel, as depicted. The DRPC waits for the return of each truth function 501. Truth functions pass the parameters they have found to FR objects 505 as defined within the diagnostic execution workspace 510 created for instance of the autonomic diagnostic in question, with these parameters being used in conjunction with the FRs to perform necessary evaluations required by the truth functions 501. Then the DRPC converts at evaluation 506 the returns from the evaluations of these FR objects 505 into a single truth value (e.g., TRUE or FALSE) for consequent computation. For example, a truth function “NotOperable” for a particular brand of network switch might query appropriate foundation rules to determine if the NotOperable value means ‘available’ or ‘unavailable’ for production use (those two values being valid for the brand of switch in question). If the return is not ‘available’ or ‘unavailable’, then the truth function will return a TRUE, otherwise, a FALSE. Once all the truth functions have returned their truth values, a Boolean evaluation can be performed, and the resulting truth value is retuned to the DRPC. When an AAR's antecedent returns TRUE, the DRPC then invokes the appropriate consequent of the AAR, and when FALSE, the next level of the AAR is accessed and considered.

In the case of a RSE trying to determine why the traffic is not being filtered by a firewall device “dev002” having an associated firewall daemon “d01” and firewall appliance “FA025”, the antecedents and consequents, could, for example, be set up as follows:

dstep = {check if “d01” of dev002 is alive}
truth function = {If d01 is not alive & FA025 is not alive}

consequent −> {continue to AAR02}
antecedent −> {If d01 is alive}

consequent −> {continue to AAR03}

The above example shows a truth function with two antecedents applied using an “and” logic. The consequent of both d01 and FA025 being not alive is for AAR02 to be invoked next by the DRPC. AAR02 could be, for example, an AAR for investigating why FA025 is not alive. The consequent of d01 being alive is for AAR03 to be invoked, which could be, for example, an AAR causing the agent to continue to check on a rules file loader.

The above example demonstrates how FRs and GDRs for related firewall appliance device FA025, which rules have been pre-loaded into the diagnostic execution workspace for the current instance of the autonomic diagnostic agent, are used in evaluating the truth functions for a given the AARs. For example, the FR in question is written as such to reflect that d01 of dev002 must be running in order for the traffic to be filtered as desired. If FA025 is not alive, then appropriate GDR objects will be accessed via AAR02 to determine and isolate the FA025's component level problem (components such as, e.g., a network interface or its software driver).

Some consequents can send a message to the diagnostic execution workspace, but others may alternatively attend to matters internal to a FR. Consequents may change a processed object. For an instance, a diagnostic process may be started on a processed object, such as a storage subsystem, and then later canceled as a result of a truth function calculation. This cancellation could be due to an exception being experienced by one of the components of the storage subsystem, such as a fiber channel. Other suitable AAR consequents can include the re-routing of work, the generating of new work, or the requesting of approvals. Consequents that initiate user (i.e. RSE) approval or work redirection requests can be required to wait for the response to such requests, making the overall execution of a FR and dstep also wait. In this manner, consequents can leave traces of their activity in the diagnostic execution workspace. In the user approval example above, the consequent can cause the daemon to create a “wait” event in an exception event list. Similarly, warnings, correctable or fatal errors likewise could be entered into an exception list.

Initial dsteps of a dscript may often cause the creation of new processed objects. Subsequent dsteps will often modify these new processed objects as well as other pre-existing objects.

The outcome of a dstep run may also result in sending a new execution request. For example, a dstep may determine that a web server is not receiving network traffic because of a down firewall, and may decide to start a firewall daemon as a workaround, then to see if that clears the original problem of the web server. So, the new execution request is the starting of a firewall system.

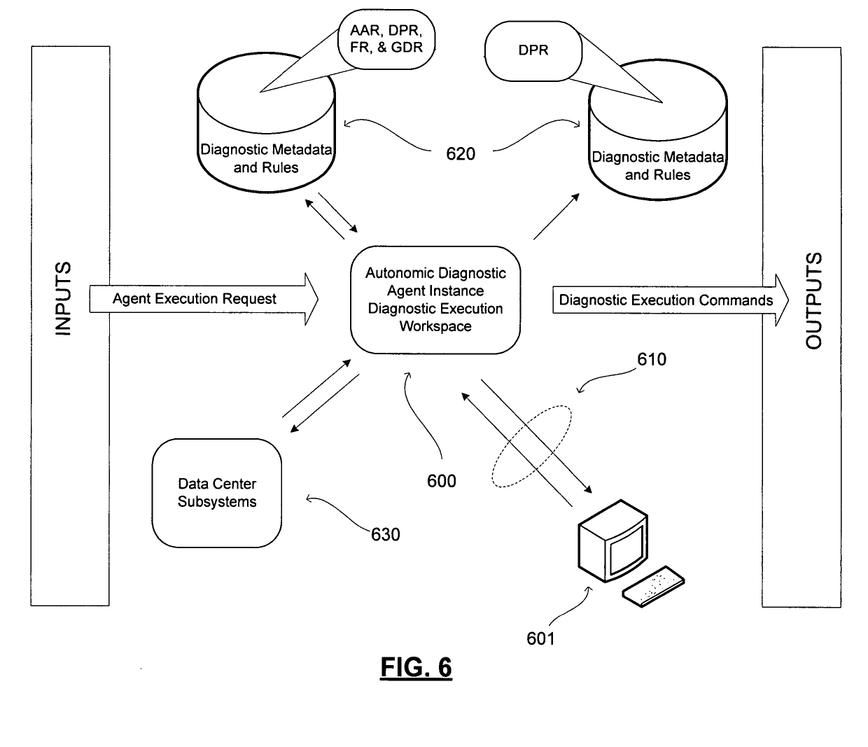

As depicted in the schematic diagram of FIG. 6, the diagnostic execution workspace 600 of a given autonomic diagnostic agent's execution process is associated with various primary resources of the diagnostic architecture. These primary resources are generally represented here in FIG. 6 collectively as data center subsystems 630. Notably, the RSE user 601 as depicted has remote control via the user interface 610 into the workspace 600 of a current autonomic diagnostic agent instance occurring within the service interface architecture, and the RSE user 601 can monitor the actions of the instance and its related telemetry data and other outputs. Further, as described above with respect to FIG. 4, inputs into the process in the form of various rules are taken from a metadata and rules database 620. Notably, during the output phase, there can be real-time modification to the rules and metadata database 620 as a result of a direct encounter of a change by an agent, such as when a certain device within a subsystem (e.g., an I/O controller in a storage subsystem) may have been upgraded to a higher version, but the change was not reflected in the rules database. As depicted in FIG. 6, during the execution of an autonomous diagnostic agent, AAR, FR and DPR are static and primarily used for fault diagnosis and isolation purposes. DPR, however, can be enhanced based on feedback/input from the execution runs.

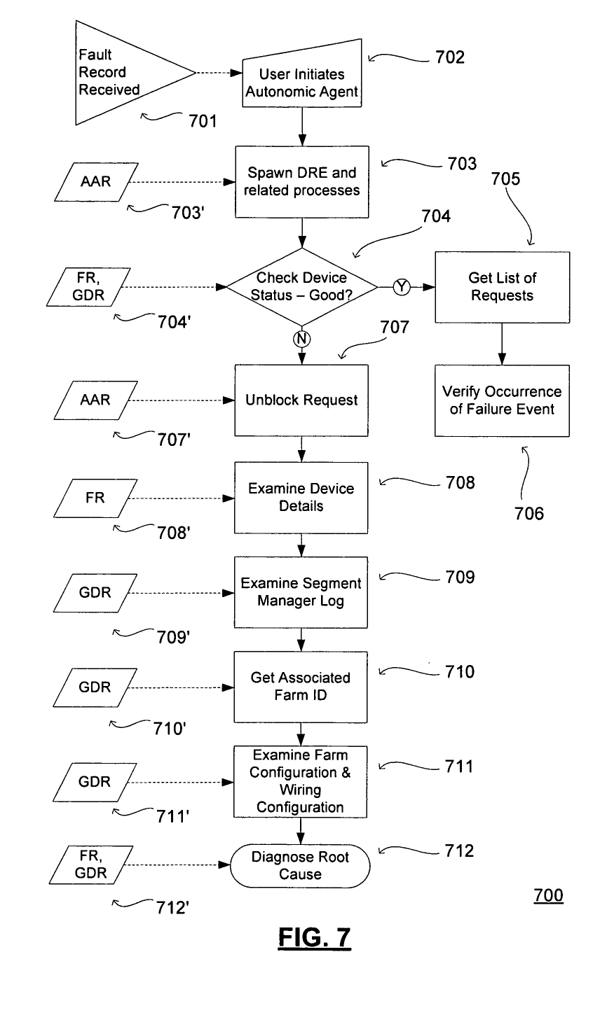

Turning now to FIG. 7, there is depicted the steps and inputs of an exemplary autonomic diagnostic agent process 700 according to one embodiment of the present invention. The rectangular elements as depicted therein are generally processing blocks and represent the implementation of computer software instructions or groups of instructions by the autonomic diagnostic agent. The diamond shaped element represents a specific decision block by the autonomic diagnostic agent (various “decisions” are made by the agent in each processing block step, but obviously not all are depicted in the drawing). The parallelogram elements depict inputs into the process. Alternatively, of course, the processing and decision blocks can represent steps performed by functionally equivalent circuits such as a digital signal processor circuit or an application specific integrated circuit (ASIC). Additionally, it should be noted that FIG. 7 depicts a process 700 specific to one particular diagnostic agent and is intended only to depict generally as an example how such an agent is utilized and how that agent interacts with rules according to the present invention.

Process 700 is triggered by the receipt by a RSE of an event report at 701, such as a fault record. The RSE at step 702 reviews the event report and then initiates an appropriate autonomic diagnostic agent at step 702. The command by the RSE user spawns a diagnostic agent, which includes a DRE and its related processes at step 703. As shown in the drawing, the diagnostic agent considers appropriate ones of the AAR as inputs 703′ as dictated by the appropriate dscript. The diagnostic agent therefore now knows which dsteps it needs to perform and in which order.

Next, at step 704, the autonomic diagnostic agent performs a check to see what the current status of the faulted device (in this particular example, a firewall). This check is performed in conjunction with the FR and GDR for the particular device as depicted by input element 704′. If the firewall device is indeed operating as expected (i.e., has a “good” status), the autonomic diagnostic agent proceeds to step 705 as depicted and obtains a list of requests, and then goes through a checklist of steps to determine why the device had a critical event at step 706. In the event that the firewall device is found to have a “bad” or undesirable status at step 704, the agent proceeds to the remainder of the process 700 as depicted.

To diagnose the bad status of the device, the agent thereafter performs various diagnostic steps as dictated by the appropriate rules and dscripts for the agent. At step 707 in this example, the autonomic diagnostic agent, in consideration of appropriate AARs at 707′, first unblocks the device in question and lets it be automatically replaced within the appropriate farms in the grid, thus removing it from the available device pool.

Notably, while not depicted explicitly in FIG. 7, it should be understood that the transition of the agent process from step to step (e.g., step 707 to step 708) would be dictated by the appropriate dscript/dsteps for the agent in question and, in turn, AARs and their respective truth functions, as described above. This consideration of AARs at each step transition has not been explicitly depicted in FIG. 7 for sake of clarity, but it should be considered implicit in the transition from each subsequent step taken by the autonomic diagnostic agent. For example, AAR can assist an autonomic diagnostic agent in deciding whether to fault isolate a device, whether to unblock a request representing a grid action (that is not yet completed), to go parse and examine a segment manager log, to analyze particular farm configuration markup represented by farm markup language (“FML”) or wiring connectivity represented by wiring markup language (“WML”), and generally to decide which step to perform after completing a particular step.

Next, the autonomic diagnostic agent will examine the device details at step 708 in consideration of appropriate FR rules for the device as inputs 708′. As noted above, FR define characteristics that apply to a particular kind of device, and encapsulate the impact of software upgrades (e.g., patches) and hardware modifications (e.g., chip change). For a firewall as in this example, checking the device details can include, as defined by the FRs checking the firewall appliance, one or more firewall software daemons, a firewall access logic file, a filter located in the operating system's kernel, a traffic log for the firewall, and the like. The process 700 of this autonomic diagnostic agent thereafter at step 709 examines the appropriate segment manager log, which is used to inform the manager of any impacted farms, and then at step 710 gets the associated farm ID(s) for the impacted farm(s) using GDR inputs 709′ and 710′ as depicted.

Once the appropriate farm ID is identified, the process 700 examines at step 711 the configuration for the device, which includes parsing the configuration files based on FML for farm level logical details, WML for physical connectivity information, Monitoring Markup Language (“MML”) for monitoring attributes and Farm Export Markup Language (“FEML”) for determining farms that were exported or moved to other parts of the data center. This parsing of files would be useful, for example, for tracing any clues with respect to the failed device as defined by the GDR inputs 711′. Finally, the process concludes at step 712 by diagnosing the potential root cause for the failure in consideration of appropriate FR and GDR inputs 712′. This diagnosis would then be reported to the RSE user.

With regard to the process 700 depicted in FIG. 7, it will be understood by one of ordinary skill in the art that autonomic diagnostic agents of the present invention are intended to be used by a RSE to substantially automate many of the steps that typically would otherwise need to be done by the RSE to effectively research and diagnose faults and other error conditions in a grid-based computing network. However, understandably, certain steps still must be or are preferred to be performed by the RSE. In this regard, several use cases will hereafter be presented to illustrate how one autonomic diagnostic agents of the present invention would assist RSEs.

Table 2 below depicts a use case providing an example of the activities that may typically be undertaken when troubleshooting a failed farm device in a grid-based computing network. The table illustrates various executable steps that can be undertaken, either directly by a RSE or by an autonomic agent launched by a RSE, which interface with infrastructure daemons of the grid-based network and the diagnostic architecture as described above. As seen in Table 2, the first column indicates step by step actions that may be undertaken during that use case to trouble shoot a failed farm device. The second column indicates an “actor” for the corresponding action, including the RSE and an autonomic diagnostic agent (abbreviated as “ADA” in Table 2). Table 2 therefore indicates that, while some steps in trouble shooting a failed farm device must be performed by a RSE, many of them can also be executed by autonomic on-demand agents that are initiated by the RSE.

TABLE 2

| Action | Actor |
|---|---|
| Get a list of customers. | RSE |
| Select the customer and the Grid data | RSE |
| center in question. | |
| View current set of tasks for the | RSE |
| infrastructure director and their | |
| statues with a command: “request −l” | |
| (or “request −lf <farm_id>”, if farm | |
| id is known) Alternatively, display | |
| critical events for the farm in | |
| question and identify the failed device. | |
| Look at the device status. Verify | RSE or ADA |
| that the physical device has actually | |
| failed and it is not a spurious error | |
| (due to temporary network outages). | |
| If the device has not failed, delete | RSE or ADA |
| the request by executing | |
| “request −d <request_id>” | |
| If the device has really failed, | |
| unblock the request with | |
| “request −u” (since it is | |
| blocked by default) and let it be | |
| replaced automatically by the | |
| director. (Or, issue “replacedevice” | |
| command.) | |
| Examine the device details. | RSE or ADA |
| Examine the log of the segment manager | RSE or ADA |
| that informs the farm manager of | |
| the device's farm. | |
| Get the associated farm ID. | RSE or ADA |
| Examine (DA-Parse) FML (or Farm | RSE or ADA |
| Markup Language) for the farm | |
| in question. | |
| Examine (DA-Parse) the WML (or | RSE or ADA |
| Wiring Markup Language) to verify | |
| physical connectivity. | |
| Determine the root cause. | RSE or ADA |

In Table 2 above, several UNIX shell commands are provided as examples (the use case assuming a UNIX operating environment). Notably, the steps of Table 2 which may be preformed by an autonomic diagnostic agent generally correspond to the process 700 of FIG. 7, thus illustrating how such an autonomic diagnostic agent process can be advantageously employed.

FIG. 8 illustrates how the DRSM enables the explosion of a single dscript into multiple constituent dsteps and EPs through the loading of various rules from the rules database and the creation of a web of states (“WOS”) from those rules. The WOS created by the DRSM is a plurality of tables, with one table for each of the dsteps and EPs within the dscript(s) relating to the current agent instance. This WOS is tabularly maintained in cache memory and provides to the DRPC readily accessible information about the dsteps and EPs, including completion values and the next dstep/EP that needs to be executed based on those completion values.

As depicted in FIG. 8, each dstep within a dscript has formed by the DRSM a corresponding diagnostic step table 801a, 801b, and 801c comprised of three columns.

Each table uniquely corresponds to and describes a particular dstep as that dstep is defined within the relevant dscript. In the example of FIG. 8 for a dscript having a number n dsteps, table 801a would correspond to a first dstep, dstep1, table 801b would correspond to second dstep, dstep2, and table 801c corresponds to the nth dstep, dstepn. In this manner, the WOS would consist of n individual diagnostic step tables. A first column 802 in each table identifies a completion state value, or return value, of a particular diagnostic execution that would occur during that dstep (as defined by the appropriate rules). When a dstep is completing its associated task, it sets a completion state value, e.g., a value stored in memory, in the diagnostic execution workspace. If a dstep task had seven possible completion states, then there would be seven corresponding completion state values, for example, v1 through v7. A completion state value could be as simple as the result of a “ping<server_name>” command performed during a dstep. In the case of such a ping, v1 and v2 could represent two possible completion state values for the result of ping, where v1=‘server_name alive’ and v2=‘server_name not alive’. Referring to the example of a firewall and firewall appliance server discussed above, the ping test may have been run on the firewall appliance server to see if it is running before diagnosing further its characteristics based on versions and granular components using FRs and GDRs.

A second column 803 identifies the next action, dstep or EP, that should be executed by the DRE based upon the occurrence of the corresponding completion state values listed in the first column 802. A third column assigns a transition rule identifier, or “TR-ID”, thus forming a triple-column set. This TR-ID enables each row in a diagnostic step table, and thus each result of a dstep, to be referenced readily by other data structures between the DRPC and DRE. This triple colunm set, also referred to herein as a “dstep 3-tuple”, represents a rule defining the transition that enables the DRPC to use the WOS to determine the next dstep, or cause the instance to invoke an EP if there is a diagnostic exception. A dstep, for example in the case of the firewall appliance discussed above, might be running a memory test on the appliance and may come across a parity error, which is represented by the return of execution field value v2. The diagnostic step table 801 for dstep1 dictates that the instance, when execution field value v2 is returned, next fires off a message via an EP, ep01, instead of executing another dstep next. EP ep01 could, for example, send a warning message or a fault message to the RSE via the user interface depending on the type and function of the system. Thus, the presence of the completion value of v2 in the diagnostic execution workspace would make the DRPC transition into ‘tr1-ep01’ in the next step, with an EP being fired. The 3-tuple in this case is: {v2, ep01, tr1-ep01}, and the DRPC stores the TR-ID to record the dstep it has just completed and the next action to take.

The WOS established from the rules by the DRSM having thus been described, the processes by which the DRPC proceeds through the dsteps and EPs of a given autonomic diagnostic agent instance according to preferred embodiments of the present invention will now be discussed. According to such preferred embodiments, a diagnostic request by an initiated agent results in the DRPC creating a Diagnostic Execution (“DE”) subprocess that handles the tasks directly associated with stepping through and invoking the ordered dsteps and EPs and, simultaneously, recording the results of those actions. A given DRPC contains records of the sets of all currently active executions, including its own DE subprocess plus those records relating to other diagnostic executions completed within a recent past timeframe for the virtualized data center in question. This timeframe parameter, for example, may be designed as a RSE-programmable variable through the telemetry interface.

Each DE subprocess is associated with a diagnostic execution workspace allocated in memory within the DRPC's process space. This diagnostic execution workspace serves as an environment for loading the relevant rules objects and maintaining the execution values, processing active execution sets of current dscript's dsteps, and like functions during the instance. Thus, the diagnostic execution workspace serves as an information clearinghouse for all of the objects in the diagnostic system encompassed by or relevant to a particular autonomic diagnostic agent.

Referring now to FIG. 9, there is schematically depicted the interaction of the DPRC 901 with a dscript 902 and rules 904 in the initiating of sequential autonomic diagnostic agents. As described above, the DRPC 901 subprocess functions to centrally maintain and manage the various diagnostic activities that make up a current diagnostic agent instance 900. These activities are organized as dsteps which are contained within a dscript 902. The dsteps, or EPs as necessary, may invoke subsequent instances of autonomic diagnostic agent processes 900b as shown in FIG. 9. Alternatively and/or additionally, the current diagnostic agent instance 900 may in turn have been invoked by prior instances of autonomic diagnostic agent processes 900a. The DRPC proceeds through the dscript and accesses the appropriate rules 904 that have been loaded into the diagnostic execution workspace 903. As described above, the DRPC 901 for the instance 900 consults the WOS 905 and the rules which were previously loaded into the diagnostic execution workspace 903 by the DRSM.

Whenever a new agent instance is initialized, whether it be sequentially and automatedly as depicted in FIG. 9 or manually by a RSE, that agent instance's DRSM establishes the WOS and state-transition rules for moving between the dsteps. DRSM scans the rule base pertaining to the agent's scope, and loads appropriate dscript/dsteps-based state tables in the WOS memory cache. Having this information memory-allocated in cache helps to speed the process of the DRPC accessing a particular transition rule that maps to a subsequent dstep. The loading of cache tables may take multiple iterations depending on the number and size of the dscripts that can fit at one time into the WOS' available memory cache.

In these embodiments, the DRE process space contains and manages the tasks associated with the AARs invoked by a present instance of an autonomic diagnostic agent. Each time a DE completes the tasks associated with and dictated by a dstep, it thereafter invokes a diagnostic rules controller (“DRC”) subprocess within the DRE which selects and fires off the appropriate AAR based on the table-driven logic in the DRC's cache table. The process by which the DE and the DRC interact to proceed through subsequent dsteps and related AARs is depicted schematically in FIG. 10.

As shown in FIG. 10, the DRC 1001, as a background subprocess of the DRE for a diagnostic agent daemon 1000, invokes AARs 1004 in succession based on the result of a dstep loaded into the diagnostic execution workspace 1003 by a DE 1005. There is one table from the DRC cache consulted by the DRC 1001 per dstep within the dscript (which table may be loaded into the diagnostic execution workspace, as described above). In certain preferred embodiments, the DRC cache may contain at least on agent action table 1002 that corresponds to one or more dsteps in a dscript and describes how those dsteps are to proceed according to referenced AARs. There can be multiple AARs consulted by an autonomic agent process for a single dstep, and each such agent action table contains three columns of information; dstep and its corresponding consequent (or result) type and severity level. Thus, a 4-tuple defined as {dstep, consequent type, severity level, AAR} decides the next AAR to be executed, and thus can initiate directional changes, both minor and major, in the diagnostic agent's logic during an execution of a troubleshooting process. Thus, the state tables in the DRC cache would be consulted for transitions between dsteps and EPs, and the agent action tables would be consulted during invocation of an AAR.

When a rule has completed its processing, or, in the case of a wait rule, has sent its original request, the DE 1005 sends a return signal to the DRC 1001. This return informs the controller if the consequent fired, and the DRC 1001 uses this information to determine whether to invoke the next severity class of rules (i.e., “drill down” the task further). When all the applicable rules have been invoked, the DRC 1001 signals the DE that it has completed the current dstep. This “dstep completed” signal returns control to the DE, initiating the DE to check an exception event list to determine if any special events have occurred during that dstep. In the normal case (i.e. without any exceptions), these lists will be empty, and the DE continues execution of the instance by enabling the DRC 1001 to continue on to the next dstep or EP as dictated by the dscript for the diagnostic agent instance. If there are exceptions, then appropriate EPs are invoked. In the case of no exceptions, the DRC then consults the appropriate table 1002 from the DRC cache as depicted to compute a new dstep according to the return value(s) from the prior dstep.

During task performance by the DE 1005 within a diagnostic agent instance, processed objects 1007 and referenced objects 1006 may be consulted and/or created. Processed objects are those diagnostic objects created or modified by the activities of a diagnostic execution. Their creation, use and/or modification represents the primary diagnostic tasks and goals of the autonomic diagnostic (troubleshooting) process. The processed object collection of a given autonomic diagnostic agent instance allows local and directly addressable access, interacting with persistent object or information storage resources (such as diagnostic parameters in the rules database for a device such as a server, a switch or a firewall). Conversely, referenced objects are those whose attribute values are used by the diagnostic process during execution. The collection of referenced objects provides read-only local access to persistent objects for a diagnostic agent instance. Referring again to the example of a firewall device as discussed above, for example, a firewall device object can have attributes pertaining to the firewall appliance (e.g., operating system, etc.), the firewall daemon, a firewall traffic-filtering rules file, and the like. During execution of a diagnostic agent, the firewall daemon may be brought down and back up as a result of the rule consequent. In this regard, the firewall would become a processed object within the context of that diagnostic agent instance. Conversely, the configuration of the firewall appliance can be a referenced object if its parameters are not going to change because of dscript executions. In this regard, a dscript may read the firewall configuration files, e.g., its firewall traffic-filtering rules file, to learn its sequence, but it may not change its rules in order to troubleshoot.

As depicted in FIG. 11, the diagnostic execution workspace 1110 is initialized whenever a new autonomic diagnostic agent instance is requested. The new agent request message will typically contain, among other parameters, a reference to some processed object created by a requesting dstep. The DRPC allocates and creates and initializes the diagnostic execution workspace. Typically, the DRPC creates a new DE among its active diagnostic execution set 1113 to execute this request, and the DE will initialize the execution environment with the parameters it has received in the execution request message. Once the execution is created, the DRPC sends the return signal to the requesting diagnostic process object, identifying the created execution. The processed object may be waiting for further execution. In such cases the DRPC would create the execution environment for it and informs it by this return signal. For example, a dstep may entail checking a network interface (as a processed object) with an “ifconfig” command rule within a FR rule object. However, this check alone may not suffice for ascertaining the status of the interface, so further testing is in order based on additional FRs to be executed in subsequent dsteps. But, before such subsequent dsteps are executed, a return signal may be utilized to indicate the downed network interface to be brought “up” for further network status verification for capture of any TCP (Transport Control Protocol) states.

In the manner described above, the instance will request the script from the WOS for its first dstep. The dstep is placed in the execution's “active” register 1111, time stamped, and then invoked by the DRPC as described above with respect to FIG. 11. The active register has the role of recording the previous dstep action into the diagnostic level execution log 1112 whenever it is replaced with a new one. These actions create a diagnostic log over a period of time for each dscript, which is of course useful for various detailed investigation that may become necessary at a later time. In particular, this diagnostic log can be written to long term storage 1115 to serve the role of providing enterprise-level event traceability for auditing, performance measurement or non-repudiation purposes.

Further, as noted above, during execution of a diagnostic agent instance, one or more exception events can occur, which occurrence would be recorded in a diagnostic exception event list 1114. This event list 1114 would be consulted by the DRE as described above to determine whether an appropriate EP needs to be invoked.

Active diagnostic execution set 1113 as depicted represents a set of dsteps to be run in a sequence, such as dictated by a dscript, that is loaded into the diagnostic execution workspace 1110 for a single diagnostic agent instance. Notably, these dsteps could be run autonomously or as a result of a RSE's choice (i.e., such as where a RSE elects to manually step through the diagnostic tasks of a particular agent).

While the above detailed description has focused on the implementation of autonomic diagnostic agents utilizing software, one of ordinary skill in the art will readily appreciate that the process steps and decisions may be alternatively performed by functionally equivalent circuits such as a digital signal processor circuit or an application specific integrated circuit (ASIC). The process flows described above do not describe the syntax of any particular programming language, and the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

It is to be understood that embodiments of the invention include the applications (i.e., the un-executed or non-performing logic instructions and/or data) encoded within a computer readable medium such as a floppy disk, hard disk or in an optical medium, or in a memory type system such as in firmware, read only memory (ROM), or, as in this example, as executable code within the memory system (e.g., within random access memory or RAM). It is also to be understood that other embodiments of the invention can provide the applications operating within the processor as the processes. While not shown in this example, those skilled in the art will understand that the computer system may include other processes and/or software and hardware subsystems, such as an operating system, which have been left out of this illustration for ease of description of the invention.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that the invention should not be limited to the described embodiments but rather should be limited only by the spirit and scope of the appended claims. Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

I claim:

1. A method for remotely diagnosing fault events in a grid-based computing system, the method comprising:
establishing a diagnostic metadata and rules database containing rules describing elements of and configuration aspects of said grid-based computing system, said rules comprising software objects;
establishing one or more diagnostic scripts each adapted to identify potential causes for particular fault events that may occur in said computing system, each said diagnostic script referencing said rules in said database to analyze metadata produced by said computing system;
receiving an indication of a fault event after it occurs in said computing system; and
initiating an autonomic diagnostic agent process in said computing system according to a diagnostic script associated with said occurred event, said autonomic diagnostic agent process comprising a rules-based engine that includes a diagnostic rules state machine subprocess and a diagnostic rules process controller subprocess, wherein said diagnostic rules state machine subprocess is adapted to load from the database into a diagnostic execution workspace the state-transition rules that establish how the engine moves between various diagnostic steps of the diagnostic script, and said diagnostic rules state machine subprocess is adapted to consider said loaded rules to perform appropriate diagnostic tasks as defined by said diagnostic steps of said associated diagnostic script, wherein said autonomic diagnostic agent process thereby provides an indication of a possible root cause for said occurred event in light of metadata obtained from said computing system.

2. The method of claim 1, wherein said indication of said occurred fault event is characterized by a fault monitoring subsystem of said computing system according to an established event framework, said framework defining events according to a plurality of event types and corresponding event sub-types for each event type and a corresponding severity level for said sub-types.

3. The method of claim 2, wherein said diagnostic scripts further describe event processors, said event processors being functions that are adapted to manage units of execution work upon the occurrence of an event as defined by said event framework, wherein said event processors include exception processors and synchronization processors.

4. The method of claim 1, wherein said rules being of types including:
i) diagnostic process rules defining procedures for diagnosing resources in said computing system;
ii) agent action rules relating to transitioning of steps for diagnosing said computing system, said agent action rules being used by said diagnostic rules process controller to define truth functions;
iii) granular diagnostic rules defining procedures for diagnosing finer components of said resources, wherein said diagnostic rules process controller subprocess considers one or more agent action rules for each diagnostic step; and
iv) foundation rules defining characteristics that apply to a particular family of resources;
wherein said resources include at least one of devices, subsystems, software, hardware and data structures of said computing system

5. The method of claim 4, wherein said truth functions are used by a diagnostic execution subprocess initiated by said diagnostic rules process controller subprocess to analyze one or more antecedents to determine an appropriate consequent, and said determined consequent affecting subsequent diagnostic tasks of said autonomic diagnostic agent.

6. The method of claim 4, wherein a diagnostic rules controller subprocess is invoked for said consideration of said agent action rules, said diagnostic rules controller subprocess consulting at least one agent action table corresponding to a particular relevant agent action rule.

7. The method of claim 1, wherein said indication of said occurred fault event is communicated by a fault monitoring subsystem of said computing system in a diagnostic event record, said diagnostic event record containing:
i) event data concerning said occurred fault and an associated resource in the computing system; and
ii) diagnostic telemetry information comprising data about the resource that experienced the event and concerning operation of the resource up to the occurrence of the fault event.

8. The method of claim 1, wherein said indication of a possible root cause for said occurred event comprises a derived list of suspected failed resources.

9. The method of claim 1, wherein said diagnostic rules state machine subprocess obtains necessary rules from said database after initialization of said autonomic diagnostic agent instance, said obtained rules being used by said diagnostic rules process controller to compile a web of states within diagnostic execution workspace, wherein said web of states comprises one or more state tables with each diagnostic step of said diagnostic script for said initiated autonomic diagnostic agent corresponding to a state table, said one or more state tables being maintained in cache memory so as to provide said diagnostic rules process controller subprocess with immediate access to rules relating to a current configuration of said computing system and said fault event, said web of states being customized to said initiated autonomic diagnostic agent.

10. The method of claim 9, wherein said diagnostic steps are invoked sequentially by said diagnostic rules process controller subprocess in accord with said web of states.

11. The method of claim 1, further comprising establishing a data center virtualization architecture in said grid-based computing system, said virtualization architecture including a grid diagnostic core in communication with a diagnostic management application, said application adapted to be accessible by a remote service engineer user to received fault event indications and initiate an autonomic diagnostic agent process, wherein said grid diagnostic core includes said database, a grid diagnostic telemetry interface, a telemetry configurator in communication with said telemetry interface and said database, a diagnostic kernel in communication with said telemetry configurator and said database, and a diagnostic service objects and methods library in communication with said diagnostic kernel, said diagnostic kernel adapted to spawn instances of autonomic diagnostic agent processes within said architecture.

12. A computer readable medium having computer readable code thereon for remotely diagnosing grid-based computing systems, the medium comprising:
instructions for establishing an electronically accessible diagnostic metadata and rules database containing rules describing elements of and configuration aspects of said grid-based computing system, said rules comprising software objects;
one or more diagnostic scripts each adapted to identify potential causes for particular fault events that may occur in said computing system, each said diagnostic script referencing said rules in said database to analyze metadata produced by said computing system;
instructions for receiving an indication of a fault event after it occurs in said computing system and displaying said fault to a user; and
instructions enabling said user to initiate an autonomic diagnostic agent process in said computing system according to a diagnostic script associated with said occurred event, said autonomic diagnostic agent process comprising a rules-based engine that includes a diagnostic rules state machine subprocess and a diagnostic rules process controller subprocess, wherein said diagnostic rules state machine subprocess is adapted to load from the database into a diagnostic execution workspace the state-transition rules that establish how the engine moves between various diagnostic steps of said associated diagnostic script, and said diagnostic rules state machine subprocess is adapted to consider said loaded rules to perform appropriate diagnostic tasks as defined by said diagnostic steps of said associated diagnostic script; and
wherein said autonomic diagnostic agent process thereby provides an indication of a possible root cause for said occurred event in light of metadata obtained from said computing system.

13. A grid-based computing system adapted to provide partially automated diagnosis of fault events, the computing system comprising:
a memory;
a processor;
a persistent data store;
a fault monitoring subsystem;
a communications interface; and
an electronic interconnection mechanism coupling the memory, the processor, the persistent data store, and the communications interface;
wherein said persistent data store contains a diagnostic metadata and rules database storing rules describing elements of and configuration aspects of said grid-based computing system, said rules comprising software objects, and said persistent data store further contains one or more diagnostic scripts each adapted to identify potential causes for particular fault events that may occur in said computing system, each said diagnostic script referencing said rules in said database to analyze metadata from said computing system;
wherein said fault monitoring subsystem is adapted to characterize an occurred fault event according to an established event framework, said framework defining events according to a plurality of event types and corresponding event sub-types for each event type and a corresponding severity level for said sub-types;
and wherein the memory is encoded with an application that when performed on the processor, provides a diagnostic process for processing information, the diagnostic process operating according to one of said diagnostic scripts and causing the computer system to perform the operations of:
receiving an indication of a fault event after it occurs in said computing system; and
initiating an autonomic diagnostic agent process in said computing system according to a diagnostic script associated with said occurred event, said autonomic diagnostic agent process comprising a rules-based engine that includes a diagnostic rules state machine subprocess and a diagnostic rules process controller subprocess, wherein said diagnostic rules state machine subprocess is adapted to load from the database into a diagnostic execution workspace the state-transition rules that establish how the engine moves between various diagnostic steps of the associated diagnostic script, and said diagnostic rules state machine subprocess is adapted to consider said loaded rules to perform appropriate diagnostic tasks as defined by said diagnostic steps of said associated diagnostic script, wherein said diagnostic scripts further describe event processors, said event processors being functions that are adapted to manage units of execution work upon the occurrence of an event as defined by said event framework; and
wherein said autonomic diagnostic agent process thereby provides an indication of a possible root cause for said occurred event in light of metadata obtained from said computing system.

14. The grid-based computing system of claim 13, wherein said and rules are of types including:
i) diagnostic process rules defining procedures for diagnosing resources in said computing system;
ii) agent action rules relating to transitioning of steps for diagnosing said computing system, said agent action rules being used by said diagnostic rules process controller to define truth functions;
iii) granular diagnostic rules defining procedures for diagnosing finer components of said resources, wherein said diagnostic rules process controller subprocess considers one or more agent action rules for each diagnostic step; and
iv) foundation rules defining characteristics that apply to a particular family of resources;
wherein said resources include at least one of devices, subsystems, software, hardware and data structures of said computing system.

15. The grid-based computing system of claim 14, wherein said truth functions are used by a diagnostic execution subprocess initiated by said diagnostic rules process controller subprocess to analyze one or more antecedents to determine an appropriate consequent, and said determined consequent affecting subsequent diagnostic tasks of said autonomic diagnostic agent.

16. The grid-based computing system of claim 14, wherein a diagnostic rules controller subprocess is invoked for said consideration of said agent action rules, said diagnostic rules controller subprocess consulting at least one agent action table corresponding to a particular relevant agent action rule.

17. The grid-based computing system of claim 13, wherein said diagnostic rules state machine subprocess obtains necessary rules from said database after initialization of said autonomic diagnostic agent instance, said obtained rules being used by said diagnostic rules process controller to compile a web of states within diagnostic execution workspace, wherein said web of states comprises one or more state tables with each diagnostic step of said diagnostic script for said initiated autonomic diagnostic agent corresponding to a state table, said one or more tables being maintained in cache memory so as to provide said diagnostic rules process controller subprocess with immediate access to rules relating to a current configuration of said computing system and said fault event, said web of states being customized to said initiated autonomic diagnostic agent.

18. The grid-based computing system of claim 17, wherein said diagnostic steps are invoked sequentially by said diagnostic rules process controller subprocess in accord with said web of states.

19. The grid-based computing system of claim 13, further comprising a data center virtualization architecture established in said grid-based computing system, said virtualization architecture including a grid diagnostic core in communication with a diagnostic management application, said application adapted to be accessible by a remote service engineer user to received fault event indications and initiate an autonomic diagnostic agent process.

20. The grid-based computing system of claim 19, wherein said grid diagnostic core includes said database, a grid diagnostic telemetry interface, a telemetry configurator in communication with said telemetry interface and said database, a diagnostic kernel in communication with said telemetry configurator and said database, and a diagnostic service objects and methods library in communication with said diagnostic kernel.
